(19) United States
(12) Patent Application Publication
(10) Pub. No.: US 2017/0073556 A1
(43) Pub. Date: Mar. 16, 2017

(54) Hydrocarbon Tackifiers for Adhesive Compositions

(71) Applicant: ExxonMobil Chemical Patents Inc., Baytown, TX (US)

(72) Inventors: Ranjan Tripathy, Sugar Land, TX (US); Jennifer J. Austin, The Woodlands, TX (US); Yann Devorest, Waterloo (BE); Thomas R. Barbee, Kingwood, TX (US)

(21) Appl. No.: 15/123,269

(22) PCT Filed: Mar. 24, 2015
(86) PCT No.: PCT/US2015/022200

§ 371 Date: Sep. 2, 2016

Related U.S. Application Data
(60) Provisional application No. 61/982,694, filed on Apr. 22, 2014.

(51) Int. Cl. C09J 123/12; C09J 123/08; C09J 123/06

(52) U.S. Cl. CPC C09J 123/12; C09J 123/06; C09J 123/0853

(57) ABSTRACT

The present invention is related to an adhesive composition comprising a 50-95 wt % polymer blend and a tackifier. The blend has a first and second propylene-based polymer, both different homopolymers of propylene or a copolymer of propylene and ethylene or a C₄ to C₁₀ alpha-olefin. The blend has a melt viscosity, measured at 190° C., of 1,000 to 30,000 cP. The tackifier has a softening point of 95° C. to 115° C., an aromaticity of 3 mol % to 10 mol % aromatic protons, and a Cloud Point of 40° C. to 65° C.

### CROSS REFERENCE TO RELATED APPLICATIONS

This application claims the benefit of Ser. No. 61/982,694, filed Apr. 22, 2014, the disclosure of which is incorporated by reference in its entirety.

### FIELD OF INVENTION

The invention relates to hydrocarbon tackifiers for polyolefin adhesive compositions that can be used for packaging and woodworking applications alike.

### BACKGROUND

Adhesive composition components such as base polymers, tackifiers, waxes, functionalized polyolefins and oils are customarily provided as separate components for formulation into hot melt adhesive (HMA) compositions. In HMA packaging applications, adhesive compositions are sought that provide a desired combination of physical properties, such as reduced set time and improved mechanical strength, including fiber tear and failure mode. In HMA woodworking applications (e.g., to adhere wood boards and prepare final wood-based products), adhesive compositions are sought that provide a desired combination of stable adhesion over time indicative of broad application temperature ranges, and a long open time.

Exemplary base polymer compositions and methods of making polymer compositions for HMA applications that can be used for both packaging and woodworking applications are disclosed in U.S. Pat. Nos. 7,294,681 and 7,524,910. Various polymers described in these patents and/or produced by the methods disclosed in these patents have been sold by ExxonMobil Chemical Company as LINXAR™ polymers.

International Publication No. 2013/134038 discloses a method for producing a polymer blend having at least two different propylene-based polymers produced in parallel reactors. The multi-modal polymer blend has a Mw of about 10,000 g/mol to about 150,000 g/mol. U.S. Provisional Application No. 61/892,813 filed on Oct. 18, 2013 discloses an adhesive composition for packaging applications having 50-80 wt % of the polymer blend disclosed in International Publication No. 2013/134038 and a tackifier having a softening point of 85-135° C. and an aromaticity of 2-12 mol % aromatic protons. U.S. Provisional Application No. 61/946,084 filed on Feb. 28, 2014 discloses an adhesive composition for woodworking applications having 75-95 wt % of the polymer blend disclosed in International Publication No. 2013/134038 where the blend has a melt temperature of 75-125° C.

Many different types of polymers and tackifiers are known and have been used in HMA formulations for packaging and woodworking applications. Generally, adhesive formulations for these applications are prepared by combining polymer, tackifier, and wax in equal quantities. However, there remains a need for a tackified adhesive formulation that has the new base polymer combined with a blend of one or more tackifiers that is versatile to be used for either end use application, as compared to HMA formulations that are currently available without having a high wax content.

### SUMMARY

The foregoing and/or other challenges are addressed by the methods and products disclosed herein.

In one aspect, the present invention relates to an adhesive composition comprising: a polymer blend comprising a first propylene-based polymer, wherein the first propylene-based polymer is a homopolymer of propylene or a copolymer of propylene and ethylene or a C₄ to C₁₀ alpha-olefin; a second propylene-based polymer, wherein the second propylene-based polymer is a homopolymer of propylene or a copolymer of propylene and ethylene or a C₄ to C₁₀ alpha-olefin; wherein the second propylene-based polymer is different than the first propylene-based polymer; wherein the polymer blend has a melt viscosity, measured at 190° C. of about 1,000 to about 30,000 cP; wherein the polymer blend is present in the amount of about 50 wt % to about 95 wt % of the adhesive composition; and a tackifier; wherein tackifier has a softening point as determined by ASTM E-28 of about 95° C. to about 115° C., an aromaticity of about 3 mol % to about 10 mol % aromatic protons, and a Cloud Point of 40° C. to about 65° C.

These and other aspects of the present inventions are described in greater detail in the following detailed description and are illustrated in the accompanying figures and tables.

### DETAILED DESCRIPTION

Various specific embodiments of the invention will now be described, including preferred embodiments and definitions that are adopted herein for purposes of understanding the claimed invention. While the illustrative embodiments have been described with particularity, it will be understood that various other modifications will be apparent to and can be readily made by those skilled in the art without departing from the spirit and scope of the invention. For determining infringement, the scope of the “invention” will refer to any one or more of the appended claims, including their equivalents and elements or limitations that are equivalent to those that are recited.

The inventors have discovered adhesive compositions utilizing a new blend of one or more tackifiers combined with a base polymer, such that the adhesive composition has broad application temperature ranges, useful for packaging and woodworking applications alike. While U.S. Provisional Application No. 61/946,084, filed on Feb. 28, 2014, discloses base polymer blends useful for woodworking applications, the application does not provide guidance on the selection of one or more tackifiers to use with the base polymer. While U.S. Provisional Application No. 61/892,813, filed on Oct. 18, 2013, discloses the use of tackifiers having certain softening point and aromaticity ranges to achieve high fiber tear for packaging applications, the inventors have unexpectedly discovered that a narrow selection of those tackifiers, having a certain Cloud Point, can also impart good adhesive strength at broad temperatures, for packaging and woodworking applications alike.

The inventive adhesives may be produced using a new process platform that is more robust and lacks many of the limitations and difficulties associated with the processes employed to make LINXAR™ polymers and those disclosed in U.S. Pat. Nos. 7,294,681 and 7,524,910. Advantageously, about 50 wt % to about 90 wt % of one or more polymer blends is used in adhesive formulations when the polymer blend has a melt viscosity of about 3,000 cP to about 30,000 cP.

Advantageously, polymers used in the adhesive composition can be produced using the new process platform that share many of the characteristics of the LINXAR™ polymers that make the LINXAR™ polymers excellent polymers for use in adhesive applications. New polymers can be produced using the new process platform that possess other characteristics that, although differentiate the polymers from the LINXAR™ polymers, are believed to contribute to the new polymers' excellent adhesive performance.

### A. Methods of Preparing Polymer Blends and Compositions

A solution polymerization process for preparing polymer blends is generally performed by a system that includes a first reactor, a second reactor in parallel with the first reactor, a liquid-phase separator, a devolatilizing vessel, and a pelletizer. The first reactor and second reactor may be, for example, continuous stirred-tank reactors.

The first reactor may receive a first monomer feed, a second monomer feed, and a catalyst feed. The first reactor may also receive feeds of a solvent and an activator. The solvent and/or the activator feed may be combined with any of the first monomer feed, the second monomer feed, or catalyst feed or the solvent and activator may be supplied to the reactor in separate feed streams. A first polymer is produced in the first reactor and is evacuated from the first reactor via a first product stream. The first product stream comprises the first polymer, solvent, and any unreacted monomer.

In any embodiment, the first monomer in the first monomer feed may be propylene and the second monomer in the second monomer feed may be ethylene or a C₄ to C₁₀ olefin. In any embodiment, the second monomer may be ethylene, butene, hexene, and octene. Generally, the choice of monomers and relative amounts of chosen monomers employed in the process depends on the desired properties of the first polymer and final polymer blend. For adhesive compositions, ethylene and hexene are particularly preferred comonomers for copolymerization with propylene. In any embodiment, the relative amounts of propylene and comonomer supplied to the first reactor may be designed to produce a polymer that is predominantly propylene, i.e., a polymer that is more than 50 mol % propylene. In another embodiment, the first reactor may produce a homopolymer of propylene.

The second reactor may receive a third monomer feed of a third monomer, a fourth monomer feed of a fourth monomer, and a catalyst feed of a second catalyst. The second reactor may also receive feeds of a solvent and activator. The solvent and/or the activator feed may be combined with any of the third monomer feed, the fourth monomer feed, or second catalyst feed, or the solvent and activator may be supplied to the reactor in separate feed streams. A second polymer is produced in the second reactor and is evacuated from the second reactor via a second product stream. The second product stream comprises the second polymer, solvent, and any unreacted monomer.

In any embodiment, the third monomer may be propylene and the fourth monomer may be ethylene or a C₄ to C₁₀ olefin. In any embodiment, the fourth monomer may be ethylene, butene, hexene, and octene. In any embodiment, the relative amounts of propylene and comonomer supplied to the second reactor may be designed to produce a polymer that is predominantly propylene, i.e., a polymer that is more than 50 mol % propylene. In another embodiment, the second reactor may produce a homopolymer of propylene.

Preferably, the second polymer is different than the first polymer. The difference may be measured, for example, by the comonomer content, heat of fusion, crystallinity, branching index, weight average molecular weight, and/or polydispersity of the two polymers. In any embodiment, the second polymer may comprise a different comonomer than the first polymer or one polymer may be a homopolymer of propylene and the other polymer may comprise a copolymer of propylene and ethylene or a C₄ to C₁₀ olefin. For example, the first polymer may comprise a propylene-ethylene copolymer and the second polymer may comprise a propylene-hexene copolymer. In any embodiment, the second polymer may have a different weight average molecular weight (Mw) than the first polymer and/or a different melt viscosity than the first polymer. Furthermore, in any embodiment, the second polymer may have a different crystallinity and/or heat of fusion than the first polymer. Specific examples of the types of polymers that may be combined to produce advantageous blends are described in greater detail herein.

It should be appreciated that any number of additional reactors may be employed to produce other polymers that may be integrated with (e.g., grafted) or blended with the first and second polymers. In any embodiment, a third reactor may produce a third polymer. The third reactor may be in parallel with the first reactor and second reactor or the third reactor may be in series with one of the first reactor and second reactor.

Further description of exemplary methods for polymerizing the polymers described herein may be found in U.S. Pat. No. 6,881,800, which is incorporated by reference herein.

The first product stream and second product stream may be combined to produce a blend stream. For example, the first product stream and second product stream may supply the first and second polymer to a mixing vessel, such as a mixing tank with an agitator.

The blend stream may be fed to a liquid-phase separation vessel to produce a polymer rich phase and a polymer lean phase. The polymer lean phase may comprise the solvent and be substantially free of polymer. At least a portion of the polymer lean phase may be evacuated from the liquid-phase separation vessel via a solvent recirculation stream. The solvent recirculation stream may further include unreacted monomer. At least a portion of the polymer rich phase may be evacuated from the liquid-phase separation vessel via a polymer rich stream.

In any embodiment, the liquid-phase separation vessel may operate on the principle of Lower Critical Solution Temperature (LCST) phase separation. This technique uses the thermodynamic principle of spinodal decomposition to generate two liquid phases; one substantially free of polymer and the other containing the dissolved polymer at a higher concentration than the single liquid feed to the liquid-phase separation vessel.

Employing a liquid-phase separation vessel that utilizes spinodal decomposition to achieve the formation of two liquid phases may be an effective method for separating solvent from multi-modal polymer blends, particularly in cases in which one of the polymers of the blend has a weight average molecular weight less than 100,000 g/mol, and even more particularly between 10,000 g/mol and 60,000 g/mol. The concentration of polymer in the polymer lean phase may be further reduced by catalyst selection. Catalysts of Formula I (described below), particularly dimethylsilyl bis(2-methyl-4-phenylindenyl) zirconium dichloride, dimethylsilyl bis(2-methyl-5-phenylindenyl) hafnium dichloride, dimethylsilyl bis(2-methyl-4-phenylindenyl) zirconium dimethyl, and dimethylsilyl bis(2-methyl-4-phenylindenyl) hafnium dimethyl were found to be a particularly effective catalysts for minimizing the concentration of polymer in the lean phase. Accordingly, in any embodiment, one, both, or all polymers may be produced using a catalyst of Formula I, particularly dimethylsilyl bis(2-methyl-4-phenylindenyl) zirconium dichloride, dimethylsilyl bis(2-methyl-4-phenylindenyl) hafnium dichloride, dimethylsilyl bis(2-methyl-4-phenylindenyl) zirconium dimethyl, and dimethylsilyl bis(2-methyl-4-phenylindenyl) hafnium dimethyl.

Upon exiting the liquid-phase separation vessel, the polymer rich stream may then be fed to a devolatilizing vessel for further polymer recovery. In any embodiment, the polymer rich stream may also be fed to a low pressure separator before being fed to the inlet of the devolatilizing vessel. While in the vessel, the polymer composition may be subjected to a vacuum in the vessel such that at least a portion of the solvent is removed from the polymer composition and the temperature of the polymer composition is reduced, thereby forming a second polymer composition comprising the multi-modal polymer blend and having a lower solvent content and a lower temperature than the polymer composition as the polymer composition is introduced into the vessel. The polymer composition may then be discharged from the outlet of the vessel via a discharge stream.

The cooled discharge stream may then be fed to a pelletizer where the multi-modal polymer blend is then discharged through a pelletization die as formed pellets. Pelletization of the polymer may be by an underwater, hot face, strand, water ring, or other similar pelletizer. Preferably an underwater pelletizer is used, but other equivalent pelletizing units known to those skilled in the art may also be used. General techniques for underwater pelletizing are known to those of ordinary skill in the art.

International Publication No. 2013/134038 generally describes the method of preparing polyolefin adhesive components and compositions. The contents of International Publication No. 2013/134038 and its parent application U.S. Patent Application Ser. No. 61/609,020, filed Mar. 9, 2012, are both incorporated herein in their entirety.

### B. Polymers

Preferred polymers are semi-crystalline propylene-based polymers. In any embodiment, the polymers may have a relatively low molecular weight, preferably about 150,000 g/mol or less. In any embodiment, the polymer may comprise a comonomer selected from the group consisting of ethylene and linear or branched C₄ to C₂₀ olefins and diolefins. In any embodiment, the comonomer may be ethylene or a C₄ to C₁₀ olefin.

The term “polymer” as used herein includes, but is not limited to, homopolymers, copolymers, interpolymers, terpolymers, etc. and alloys and blends thereof. Further, as used herein, the term “copolymer” is meant to include polymers having two or more monomers, optionally with other monomers, and may refer to interpolymers, terpolymers, etc. The term “polymer” as used herein also includes impact, block, graft, random and alternating copolymers. The term “polymer” shall further include all possible geometrical configurations unless otherwise specifically stated. Such configurations may include isotactic, syndiotactic and random symmetries. The term “polymer blend” as used herein includes, but is not limited to a blend of one or more polymers prepared in solution or by physical blending, such as melt blending.

“Propylene-based” or “predominantly propylene-based” as used herein, is meant to include any polymer comprising propylene, either alone or in combination with one or more comonomers, in which propylene is the major component (i.e., greater than 50 mol % propylene).

In any embodiment, one or more polymers of the blend may comprise one or more propylene-based polymers, which comprise propylene and from about 2 mol % to about 30 mol % of one or more comonomers selected from C₂ and C₄-C₁₀ α-olefins. In any embodiment, the α-olefin comonomer units may derive from ethylene, butene, pentene, hexene, 4-methyl-1-pentene, octene, or decene. The embodiments described below are discussed with reference to ethylene and hexene as the α-olefin comonomer, but the embodiments are equally applicable to other copolymers with other α-olefin comonomers. In this regard, the copolymers may simply be referred to as propylene-based polymers with reference to ethylene or hexene as the α-olefin.

In any embodiment, the one or more propylene-based polymers of the polymer blend may include at least about 5 mol %, at least about 6 mol %, at least about 7 mol %, or at least about 8 mol %, or at least about 10 mol %, or at least about 12 mol % ethylene-derived or hexene-derived units. In those or other embodiments, the copolymers of the propylene-based polymer may include up to about 30 mol %, or up to about 25 mol %, or up to about 22 mol %, or up to about 20 mol %, or up to about 19 mol %, or up to about 18 mol %, or up to about 17 mol % ethylene-derived or hexene-derived units, where the percentage by mole is based upon the total moles of the propylene-derived and α-olefin derived units. Stated another way, the propylene-based polymer may include at least about 70 mol %, or at least about 75 mol %, or at least about 80 mol %, or at least about 81 mol % propylene-derived units, or at least about 82 mol % propylene-derived units, or at least about 83 mol % propylene-derived units; and in these or other embodiments, the copolymers of the propylene-based polymer may include up to about 95 mol %, or up to about 94 mol %, or up to about 93 mol %, or up to about 92 mol %, or up to about 90 mol %, or up to about 88 mol % propylene-derived units, where the percentage by mole is based upon the total moles of the propylene-derived and alpha-olefin derived units. In any embodiment, the propylene-based polymer may comprise from about 5 mol % to about 25 mol % ethylene-derived or hexene-derived units, or from about 8 mol % to about 20 mol % ethylene-derived or hexene-derived units, or from about 12 mol % to about 18 mol % ethylene-derived or hexene-derived units.

The one or more polymers of the blend of one or more embodiments are characterized by a melting point (Tm), which can be determined by differential scanning calorimetry (DSC). For purposes herein, the maximum of the highest temperature peak is considered to be the melting point of the polymer. A “peak” in this context is defined as a change in the general slope of the DSC curve (heat flow versus temperature) from positive to negative, forming a maximum without a shift in the baseline where the DSC curve is plotted so that an endothermic reaction would be shown with a positive peak.

In any embodiment, the Tm of the one or more polymers of the blend (as determined by DSC) may be less than about 130° C., or less than about 125° C., less than about 120° C., or less than about 115° C., or less than about 110° C., or less than about 100° C., or less than about 90° C., and greater than about 70° C., or greater than about 75° C., or greater than about 80° C., or greater than about 85° C. In any embodiment, the Tm of the one or more polymers of the blend may be greater than about 25° C., or greater than about 30° C., or greater than about 35° C., or greater than about 40° C. Tm of the polymer blend can be determined by taking 5 to 10 mg of a sample of the polymer blend, equilibrating a DSC Standard Cell FC at −90° C., ramping the temperature at a rate of 10° C. per minute up to 200° C., maintaining the temperature for 5 minutes, lowering the temperature at a rate of 10° C. per minute to −90° C., ramping the temperature at a rate of 10° C. per minute up to 200° C., maintaining the temperature for 5 minutes, and recording the temperature as Tm.

In one or more embodiments, the crystallization temperature (Tc) of the polymer blend (as determined by DSC) is less than about 110° C., or less than about 90° C., or less than about 80° C., or less than about 70° C., or less than about 60° C., or less than about 50° C., or less than about 40° C., or less than about 30° C., or less than about 20° C., or less than about 10° C. In the same or other embodiments, the Tc of the polymer is greater than about 0° C., or greater than about 5° C., or greater than about 10° C., or greater than about 15° C., or greater than about 20° C. In any embodiment, the Tc lower limit of the polymer may be 0° C., 5° C., 10° C., 20° C., 30° C., 40° C., 50° C., 60° C., and 70° C.; and the Tc upper limit temperature may be 100° C., 90° C., 80° C., 70° C., 60° C., 50° C., 40° C., 30° C., 25° C., and 20° C. with ranges from any lower limit to any upper limit being contemplated.

The polymers suitable for use herein are said to be “semi-crystalline”, meaning that in general they have a relatively low crystallinity. The term “crystalline” as used herein broadly characterizes those polymers that possess a high degree of both inter and intra molecular order, and which preferably melt higher than 110° C., more preferably higher than 115° C., and most preferably above 130° C. A polymer possessing a high inter and intra molecular order is said to have a “high” level of crystallinity, while a polymer possessing a low inter and intra molecular order is said to have a “low” level of crystallinity. Crystallinity of a polymer can be expressed quantitatively, e.g., in terms of percent crystallinity, usually with respect to some reference or benchmark crystallinity. As used herein, crystallinity is measured with respect to isotactic polypropylene homopolymer. Preferably, heat of fusion is used to determine crystallinity. Thus, for example, assuming the heat of fusion for a highly crystalline polypropylene homopolymer is 190 J/g, a semi-crystalline propylene copolymer having a heat of fusion of 95 J/g will have a crystallinity of 50%. The term “crystallizable” as used herein refers to those polymers which can crystallize upon stretching or annealing. Thus, in certain specific embodiments, the semi-crystalline polymer may be crystallizable. The semi-crystalline polymers used in specific embodiments of this invention preferably have a crystallinity of from 2% to 65% of the crystallinity of isotatic polypropylene. In further embodiments, the semi-crystalline polymers may have a crystallinity of from about 3% to about 40%, or from about 4% to about 30%, or from about 5% to about 25% of the crystallinity of isotactic polypropylene.

The semi-crystalline polymer can have a level of isotacticity expressed as percentage of isotactic triads (three consecutive propylene units), as measured by ¹³C NMR, of 75 mol % or greater, 80 mol % or greater, 85 mol % or greater, 90 mol % or greater, 92 mol % or greater, 95 mol % or greater, or 97 mol % or greater. In one or more embodiments, the triad tacticity may range from about 75 mol % to about 99 mol %, or from about 80 mol % to about 99 mol %, or from about 85 mol % to about 99 mol %, or from about 90 mol % to about 99 mol %, or from about 90 mol % to about 97 mol %, or from about 80 mol % to about 97 mol %. Triad tacticity is determined by the methods described in U.S. Patent Application Publication No. 2004/0236042.

The semi-crystalline polymer may have a tacticity index m/r ranging from a lower limit of 4, or 6 to an upper limit of 10, or 20, or 25. The tacticity index, expressed herein as “m/r”, is determined by ¹³C nuclear magnetic resonance (“NMR”). The tacticity index m/r is calculated as defined by H. N. Cheng in 17 MACROMOLECULES, 1950 (1984), incorporated herein by reference. The designation “m” or “r” describes the stereochemistry of pairs of contiguous propylene groups, “m” referring to meso and “r” to racemic. An m/r ratio of 1.0 generally describes an atactic polymer, and as the m/r ratio approaches zero, the polymer is increasingly more syndiotactic. The polymer is increasingly isotactic as the m/r ratio increases above 1.0 and approaches infinity.

In one or more embodiments, the semi-crystalline polymer may have a density of from about 0.85 g/cm³ to about 0.92 g/cm³, or from about 0.86 g/cm³ to about 0.90 g/cm³, or from about 0.86 g/cm³ to about 0.89 g/cm³ at room temperature and determined according to ASTM D-792. As used herein, the term “room temperature” is used to refer to the temperature range of about 20° C. to about 23.5° C.

In one or more embodiments, the semi-crystalline polymer can have a weight average molecular weight (Mw) of from about 5,000 to about 500,000 g/mol, or from about 7,500 to about 300,000 g/mol, or from about 10,000 to about 200,000 g/mol, or from about 25,000 to about 175,000 g/mol.

Weight-average molecular weight, M_{w}, molecular weight distribution (MWD) or M_{w}/Mₙ where Mₙ is the number-average molecular weight, and the branching index, g′(vis), are characterized using a High Temperature Size Exclusion Chromatograph (SEC), equipped with a differential refractive index detector (DRI), an online light scattering detector (LS), and a viscometer. Experimental details not shown below, including how the detectors are calibrated, are described in: T. Sun, P. Brant, R. R. Chance, and W. W. Graessley, Macromolecules, Volume 34, Number 19, pp. 6812-6820, 2001.

Solvent for the SEC experiment is prepared by dissolving 6 g of butylated hydroxy toluene as an antioxidant in 4 L of Aldrich reagent grade 1, 2, 4 trichlorobenzene (TCB). The TCB mixture is then filtered through a 0.7 μm glass pre-filter and subsequently through a 0.1 μm Teflon filter. The TCB is then degassed with an online degasser before entering the SEC. Polymer solutions are prepared by placing the dry polymer in a glass container, adding the desired amount of TCB, then heating the mixture at 160° C. with continuous agitation for about 2 hr. All quantities are measured gravimetrically. The TCB densities used to express the polymer concentration in mass/volume units are 1.463 g/mL at room temperature and 1.324 g/mL at 135° C. The injection concentration ranges from 1.0 to 2.0 mg/mL, with lower concentrations being used for higher molecular weight samples. Prior to running each sample the DRI detector and the injector are purged. Flow rate in the apparatus is then increased to 0.5 mL/min, and the DRI was allowed to stabilize for 8-9 hr before injecting the first sample. The LS laser is turned on 1 to 1.5 hr before running samples. As used herein, the term “room temperature” is used to refer to the temperature range of about 20° C. to about 23.5° C.

The concentration, c, at each point in the chromatogram is calculated from the baseline-subtracted DRI signal, I_{DRI}, using the following equation:

c=K_{DRI}I_{DRI}/(dn/dc)

where K_{DRI} is a constant determined by calibrating the DRI, and dn/dc is the same as described below for the LS analysis. Units on parameters throughout this description of the SEC method are such that concentration is expressed in g/cm³, molecular weight is expressed in kg/mol, and intrinsic viscosity is expressed in dL/g.

The light scattering detector used is a Wyatt Technology High Temperature mini-DAWN. The polymer molecular weight, M, at each point in the chromatogram is determined by analyzing the LS output using the Zimm model for static light scattering (M. B. Huglin, LIGHT SCATTERING FROM POLYMER SOLUTIONS, Academic Press, 1971):

[Kₒc/ΔR(θ,c)]=[1/MP(θ)]+2A₂c

where ΔR(θ) is the measured excess Rayleigh scattering intensity at scattering angle θ, c is the polymer concentration determined from the DRI analysis, A₂ is the second virial coefficient, P(θ) is the form factor for a monodisperse random coil (described in the above reference), and Kₒ is the optical constant for the system:

$${K}_{o} = \frac{4 {π}^{2} {{n}^{2} ( dn / dc )}^{2}}{{λ}^{4} {N}_{A}}$$

in which N_{A} is the Avogadro's number, and dn/dc is the refractive index increment for the system. The refractive index, n=1.500 for TCB at 135° C. and λ=690 nm. In addition, A₂=0.0015 and dn/dc=0.104 for ethylene polymers, whereas A₂=0.0006 and dn/dc=0.104 for propylene polymers.

The molecular weight averages are usually defined by considering the discontinuous nature of the distribution in which the macromolecules exist in discrete fractions i containing Nᵢ molecules of molecular weight Mᵢ. The weight-average molecular weight, M_{w}, is defined as the sum of the products of the molecular weight Mᵢ of each fraction multiplied by its weight fraction wᵢ:

M_{w}≡ΣwᵢMᵢ=(ΣNᵢMᵢ²/ΣNᵢMᵢ)

since the weight fraction wᵢ is defined as the weight of molecules of molecular weight Mᵢ divided by the total weight of all the molecules present:

wᵢ=NᵢMᵢ/ΣNᵢMᵢ

The number-average molecular weight, Mₙ, is defined as the sum of the products of the molecular weight Mᵢ of each fraction multiplied by its mole fraction xᵢ:

Mₙ≡ΣxᵢMᵢ=ΣNᵢMᵢ/ΣNᵢ.

since the mole fraction xᵢ is defined as Nᵢ divided by the total number of molecules:

xᵢ=Nᵢ/ΣNᵢ.

In the SEC, a high temperature Viscotek Corporation viscometer is used, which has four capillaries arranged in a Wheatstone bridge configuration with two pressure transducers. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

ηₛ=c[η]+0.3(c[η])²

where c was determined from the DRI output.

The branching index (g′, also referred to as g′(vis)) is calculated using the output of the SEC-DRI-LS-VIS method as follows. The average intrinsic viscosity, [η]avg, of the sample is calculated by:

$${[ η ]}_{avg} = \frac{\sum {{c}_{i} [ η ]}_{i}}{\sum {c}_{i}}$$

where the summations are over the chromatographic slices, i, between the integration limits.

The branching index g′ is defined as:

$${g}^{′} = \frac{{[ η ]}_{avg}}{{kM}_{v}^{α}}$$

where k=0.000579 and α=0.695 for ethylene polymers; k=0.0002288 and α=0.705 for propylene polymers; and k=0.00018 and α=0.7 for butene polymers.

Mᵥ is the viscosity-average molecular weight based on molecular weights determined by the LS analysis:

Mᵥ≡(ΣcᵢMᵢ^{α}/Σcᵢ)^{1/α}.

In one or more embodiments, the semi-crystalline polymer may have a viscosity (also referred to a Brookfield viscosity or melt viscosity), measured at 190° C. and determined according to ASTM D-3236 from about 100 cP to about 500,000 cP, or from about 100 to about 100,000 cP, or from about 100 to about 50,000 cP, or from about 100 to about 25,000 cP, or from about 100 to about 15,000 cP, or from about 100 to about 10,000 cP, or from about 100 to about 5,000 cP, or from about 500 to about 15,000 cP, or from about 500 to about 10,000 cP, or from about 500 to about 5,000 cP, or from about 1,000 to about 10,000 cP, wherein 1 cP=1 mPa·sec.

In one or more embodiments, the semi-crystalline polymer may be characterized by its viscosity at 190° C. In one or more embodiments, the semi-crystalline polymer may have a viscosity that is at least about 100 cP (centipoise), or at least about 500 cP, or at least about 1,000 cP, or at least about 1,500 cP, or at least about 2,000 cP, or at least about 3,000 cP, or at least about 4,000 cP, or at least about 5,000 cP. In these or other embodiments, the semi-crystalline polymer may be characterized by a viscosity at 190° C. of less than about 100,000 cP, or less than about 75,000 cP, or less than about 50,000 cP, or less than about 25,000 cP, or less than about 20,000 cP, or less than about 15,000 cP, or less than about 10,000 cP, or less than about 5,000 cP with ranges from any lower limit to any upper limit being contemplated.

The polymers that may be used in the adhesive compositions disclosed herein generally include any of the polymers according to the process disclosed in International Publication No. 2013/134038. The triad tacticity and tacticity index of a polymer may be controlled by the catalyst, which influences the stereoregularity of propylene placement, the polymerization temperature, according to which stereoregularity can be reduced by increasing the temperature, and by the type and amount of a comonomer, which tends to reduce the length of crystalline propylene derived sequences. Such polymers made in accordance with International Publication No. 2013/134038, when subjected to Temperature Rising Elution Fractionation, exhibit: a first fraction that is soluble at −15° C. in xylene, the first fraction having an isotactic (mm) triad tacticity of about 70 mol % to about 90 mol %; and a second fraction that is insoluble at −15° C. in xylene, the second fraction having an isotactic (mm) triad tacticity of about 85 mol % to about 98 mol %. The contents of International Publication No. 2013/134038 and its parent application U.S. Patent Application Ser. No. 61/609,020, filed Mar. 9, 2012, are both incorporated herein in their entirety.

Polymers and blended polymer products are also provided. In any embodiment, one or more of the polymers described herein may be blended with another polymer, such as another polymer described herein, to produce a physical blend of polymers. The polymer blends used in the examples of the invention are listed in Table 1 and were generally produced in accordance with the method disclosed in International Publication No. 2013/134038. The present invention is not limited to those polymers disclosed in Table 1 or described herein.

In an embodiment, the adhesive composition of the present invention includes an ethylene-based polymer such as ethylene vinyl acetate and polyethylene/ethylene copolymers. In an embodiment, the ethylene vinyl acetate has 15 wt % to 40 wt % vinyl acetate and a melt index of 30 g/10 min to 1,000 g/10 min. Useful commercially available ethylene vinyl acetates are the Escorene™ grades available from ExxonMobil Chemical. In an embodiment, the polyethylene/ethylene copolymer has a density of about 0.86 g/cm³ to 0.9 g/cm³ and a viscosity of 5 Pa-s to 200 Pa-s at 177° C. Useful commercially available polyethylenes/ethylene copolymers are the AFFINITY™ grades available from Dow Chemical. The ethylene-based polymers used in the examples of the invention are Escorene™ Ultra UL 7520 and Affinity GA 1950. Escorene™ 7520 is an ethylene vinyl acetate copolymer, having a vinyl acetate content of about 18.5 wt % and a melt index as measured according to ASTM D1238 at 190° C. and 2.16 kg of about 140 g/10 min. Affinity GA 1950 is an ethylene-octene polyolefin plastomer having a viscosity of about 17 Pa-s and a density of about 0.874 g/cm³.

In an embodiment, the adhesive composition of the present invention includes a propylene-based homopolymer. In an embodiment, the homopolymer has a viscosity of 1,000 cP to 30,000 cP at 190° C. and a softening point, as determined by ISO4625, of 70° C. to 130° C. Useful commercially available propylene-based homopolymers are the L-MODU™ grades available from Idemitsu.

### Catalysts/Activators

The polymer blends described herein may be prepared using one or more catalyst systems. As used herein, a “catalyst system” comprises at least a transition metal compound, also referred to as catalyst precursor, and an activator. Contacting the transition metal compound (catalyst precursor) and the activator in solution upstream of the polymerization reactor or in the polymerization reactor of the process described above yields the catalytically active component (catalyst) of the catalyst system. Any given transition metal compound or catalyst precursor can yield a catalytically active component (catalyst) with various activators, affording a wide array of catalysts deployable in the processes of the present invention. Catalyst systems of the present invention comprise at least one transition metal compound and at least one activator. However, catalyst systems of the current disclosure may also comprise more than one transition metal compound in combination with one or more activators. Such catalyst systems may optionally include impurity scavengers. Each of these components are described in further detail below.

The triad tacticity and tacticity index of the polymer may be controlled by the catalyst, which influences the stereoregularity of propylene placement, the polymerization temperature, according to which stereoregularity can be reduced by increasing the temperature, and by the type and amount of a comonomer, which tends to reduce the length of crystalline propylene derived sequences.

In any embodiment, the catalyst systems used for producing semi-crystalline polymers may comprise a metallocene compound. In any embodiment, the metallocene compound may be a bridged bisindenyl metallocene having the general formula (In¹)Y(In²)MX₂, where In¹ and In² are identical substituted or unsubstituted indenyl groups bound to M and bridged by Y, Y is a bridging group in which the number of atoms in the direct chain connecting In¹ with In² is from 1 to 8 and the direct chain comprises C, Si, or Ge; M is a Group 3, 4, 5, or 6 transition metal; and X₂ are leaving groups. In¹ and In² may be substituted or unsubstituted. If In¹ and In² are substituted by one or more substituents, the substituents are selected from the group consisting of a halogen atom, C₁ to C₁₀ alkyl, C₅ to C₁₅ aryl, C₆ to C₂₅ alkylaryl, and Si-, N- or P-containing alkyl or aryl. Each leaving group X may be an alkyl, preferably methyl, or a halide ion, preferably chloride or fluoride. Exemplary metallocene compounds of this type include, but are not limited to, μ-dimethylsilylbis(indenyl) hafnium dimethyl and -dimethylsilylbis(indenyl) zirconium dimethyl.

In any embodiment, the metallocene compound may be a bridged bisindenyl metallocene having the general formula (In¹)Y(In²)MX₂, where In¹ and In² are identical 2,4-substituted indenyl groups bound to M and bridged by Y, Y is a bridging group in which the number of atoms in the direct chain connecting In¹ with In² is from 1 to 8 and the direct chain comprises C, Si, or Ge, M is a Group 3, 4, 5, or 6 transition metal, and X₂ are leaving groups. In¹ and In² are substituted in the 2 position by a C₁ to C₁₀ alkyl, preferably a methyl group and in the 4 position by a substituent selected from the group consisting of C₅ to C₁₅ aryl, C₆ to C₂₅ alkylaryl, and Si-, N- or P-containing alkyl or aryl. Each leaving group X may be an alkyl, preferably methyl, or a halide ion, preferably chloride or fluoride. Exemplary metallocene compounds of this type include, but are not limited to, (dimethylsilyl)bis(2-methyl-4-(3,′5′-di-tert-butylphenyl)indenyl) zirconium dimethyl, (dimethylsilyl)bis(2-methyl-4-(3,′5′-di-tert-butylphenyl)indenyl) hafnium dimethyl, (dimethylsilyl)bis(2-methyl-4-naphthylindenyl) zirconium dimethyl, (dimethylsilyl)bis(2-methyl-4-naphthylindenyl) hafnium dimethyl, (dimethylsilyl)bis(2-methyl-4-(N-carbazyl)indenyl) zirconium dimethyl, and (dimethylsilyl)bis(2-methyl-4-(N-carbazyl)indenyl) hafnium dimethyl.

Alternatively, in any embodiment, the metallocene compound may correspond to one or more of the formulas disclosed in U.S. Pat. No. 7,601,666. Such metallocene compounds include, but are not limited to, dimethylsilyl bis(2-(methyl)-5,5,8,8-tetramethyl-5,6,7,8-tetrahydrobenz(f)indenyl) hafnium dimethyl, diphenylsilyl bis(2-(methyl)-5,5,8,8-tetramethyl-5,6,7,8-tetrahydrobenz(f)indenyl) hafnium dimethyl, diphenylsilyl bis(5,5,8,8-tetramethyl-5,6,7,8-tetrahydrobenz(f)indenyl) hafnium dimethyl, diphenylsilyl bis(2-(methyl)-5,5,8,8-tetramethyl-5,6,7,8-tetrahydrobenz(f) indenyl) zirconium dichloride, and cyclo-propylsilyl bis(2-(methyl)-5,5,8,8-tetramethyl-5,6,7,8-tetrahydrobenz(f) indenyl) hafnium dimethyl.

In any embodiment, the activators of the catalyst systems used to produce semi-crystalline polymers may comprise a cationic component. In any embodiment, the cationic component may have the formula [R¹R²R³AH]⁺, where A is nitrogen, R¹ and R² are together a —(CH₂)ₐ— group, where a is 3, 4, 5, or 6 and form, together with the nitrogen atom, a 4-, 5-, 6-, or 7-membered non-aromatic ring to which, via adjacent ring carbon atoms, optionally one or more aromatic or heteroaromatic rings may be fused, and R³ is C₁, C₂, C₃, C₄, or C₅ alkyl, or N-methylpyrrolidinium or N-methylpiperidinium. Alternatively, in any embodiment, the cationic component has the formula [RₙAH₄₋ₙ]⁺, where A is nitrogen, n is 2 or 3, and all R are identical and are C₁ to C₃ alkyl groups, such as for example trimethylammonium, trimethylanilinium, triethylammonium, dimethylanilinium, or dimethylammonium.

A particularly advantageous catalyst that may be employed in any embodiment is illustrated in Formula I.

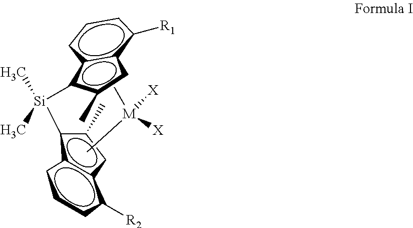

In any embodiment, M is a Group IV transition metal atom, preferably a Group IVB transition metal, more preferably hafnium or zirconium, and X are each an alkyl, preferably methyl, or a halide ion, preferably chloride or fluoride. Methyl or chloride leaving groups are most preferred. In any embodiment, R1 and R2 may be independently selected from the group consisting of hydrogen, phenyl, and naphthyl. R1 is preferably the same as R2. Particularly advantageous species of Formula I are dimethylsilyl bis(2-methyl-4-phenylindenyl) zirconium dichloride, dimethylsilyl bis(2-methyl-4-phenylindenyl) zirconium dimethyl, dimethylsilyl bis(2-methyl-4-phenylindenyl) hafnium dichloride, and dimethylsilyl bis(2-methyl-4-phenylindenyl) hafnium dimethyl.

Any catalyst system resulting from any combination of a metallocene compound, a cationic activator component, and an anionic activator component mentioned in this disclosure shall be considered to be explicitly disclosed herein and may be used in accordance with the present invention in the polymerization of one or more olefin monomers. Also, combinations of two different activators can be used with the same or different metallocene(s).

In any embodiment, the activators of the catalyst systems used to produce the semi-crystalline polymers may comprise an anionic component, [Y]⁻. In any embodiment, the anionic component may be a non-coordinating anion (NCA), having the formula [B(R⁴)₄]⁻, where R⁴ is an aryl group or a substituted aryl group, of which the one or more substituents are identical or different and are selected from the group consisting of alkyl, aryl, a halogen atom, halogenated aryl, and haloalkylaryl groups. The substituents may be perhalogenated aryl groups, or perfluorinated aryl groups, including, but not limited to, perfluorophenyl, perfluoronaphthyl and perfluorobiphenyl.

Together, the cationic and anionic components of the catalysts systems described herein form an activator compound. In any embodiment, the activator may be N,N-dimethylanilinium-tetra(perfluorophenyl)borate, N,N-dimethylanilinium-tetra(perfluoronaphthyl)borate, N,N-dimethylanilinium-tetrakis(perfluorobiphenyl)borate, N,N-dimethylanilinium-tetrakis(3,5-bis(trifluoromethyl)phenyl)borate, triphenylcarbenium-tetra(perfluorophenyl)borate, triphenylcarbenium-tetra(perfluoronaphthyl)borate, triphenylcarbenium-tetrakis(perfluorobiphenyl)borate, or triphenylcarbenium-tetrakis(3,5-bis(trifluoromethyl)phenyl)borate.

A non-coordinating anion activator may be employed with the catalyst. A particularly advantageous activator is dimethylaniliniumtetrakis(heptafluoronaphthyl) borate.

Suitable activators for the processes of the present invention also include aluminoxanes (or alumoxanes) and aluminum alkyls. Without being bound by theory, an alumoxane is typically believed to be an oligomeric aluminum compound represented by the general formula (R^{x}—Al—O)ₙ, which is a cyclic compound, or R^{x} (R^{x}—Al—O)ₙAlR^{x}₂, which is a linear compound. Most commonly, alumoxane is believed to be a mixture of the cyclic and linear compounds. In the general alumoxane formula, R^{x} is independently a C₁-C₂₀ alkyl radical, for example, methyl, ethyl, propyl, butyl, pentyl, isomers thereof, and the like, and n is an integer from 1-50. In any embodiment, R^{x} may be methyl and n may be at least 4. Methyl alumoxane (MAO), as well as modified MAO containing some higher alkyl groups to improve solubility, ethyl alumoxane, iso-butyl alumoxane, and the like are useful for the processes disclosed herein.

Further, the catalyst systems suitable for use in the present invention may contain, in addition to the transition metal compound and the activator described above, additional activators (co-activators), and/or scavengers. A co-activator is a compound capable of reacting with the transition metal complex, such that when used in combination with an activator, an active catalyst is formed. Co-activators include alumoxanes and aluminum alkyls.

In any embodiment, scavengers may be used to “clean” the reaction of any poisons that would otherwise react with the catalyst and deactivate it. Typical aluminum or boron alkyl components useful as scavengers are represented by the general formula R^{x}JZ₂ where J is aluminum or boron, R^{x} is a C₁-C₂₀ alkyl radical, for example, methyl, ethyl, propyl, butyl, pentyl, and isomers thereof, and each Z is independently R^{x} or a different univalent anionic ligand such as halogen (Cl, Br, I), alkoxide (OR^{x}), and the like. Exemplary aluminum alkyls include triethylaluminum, diethylaluminum chloride, ethylaluminium dichloride, tri-iso-butylaluminum, tri-n-octylaluminum, tri-n-hexylaluminum, trimethylaluminum, and combinations thereof. Exemplary boron alkyls include triethylboron. Scavenging compounds may also be alumoxanes and modified alumoxanes including methylalumoxane and modified methylalumoxane.

### Solvents

The solvent used in the reaction system of the present invention may be any non-polymeric species capable of being removed from the polymer composition by heating to a temperature below the decomposition temperature of the polymer and/or reducing the pressure of the solvent/polymer mixture. In any embodiment, the solvent may be an aliphatic or aromatic hydrocarbon fluid.

Examples of suitable, preferably inert, hydrocarbon fluids are readily volatile liquid hydrocarbons, which include, for example, hydrocarbons containing from 1 to 30, preferably 3 to 20, carbon atoms. Preferred examples include propane, n-butane, isobutane, mixed butanes, n-pentane, isopentane, neopentane, n-hexane, cyclohexane, isohexane, octane, other saturated C₆ to C₈ hydrocarbons, toluene, benzene, ethylbenzene, chlorobenzene, xylene, desulphurized light virgin naphtha, and any other hydrocarbon solvent recognized by those skilled in the art to be suitable for the purposes of this invention. Particularly preferred solvents for use in the processes disclosed herein are n-hexane and toluene.

The optimal amount of solvent present in combination with the polymer at the inlet to the devolatilizer will generally be dependent upon the desired temperature change of the polymer melt within the devolatilizer, and can be readily determined by persons of skill in the art. For example, the polymer composition may comprise, at the inlet of the devolatilizer, from about 1 wt % to about 50 wt % solvent, or from about 5 wt % to about 45 wt % solvent, or from about 10 wt % to about 40 wt % solvent, or from about 10 wt % to about 35 wt % solvent.

International Publication No. 2013/134038 generally describes the catalysts, activators, and solvents used to prepare the polymer blend used in the adhesive compositions. The contents of International Publication No. 2013/134038 and its parent application U.S. Patent Application Ser. No. 61/609,020, filed Mar. 9, 2012, are both incorporated herein in their entirety.

### C. Tackifier

The term “tackifier” is used herein to refer to an agent that allows the polymer of the composition to be more adhesive by improving wetting during the application. Tackifiers may be produced from petroleum-derived hydrocarbons and monomers of feedstock including tall oil and other polyterpene or resin sources. Tackifying agents are added to give tack to the adhesive and also to modify viscosity. Tack is required in most adhesive formulations to allow for proper joining of articles prior to the HMA solidifying. As used herein, the term “tackifier” includes a blend of one or more tackifiers.

“Softening Point” is the temperature, measured in ° C., at which a material will flow, as determined by ASTM E-28, (Revision 1996). Softening Point of a blend of one or more tackifiers is calculated by formula I.

$$\frac{1}{Tackifier Blend Softening Point} = \sum ( ( \frac{Tackifier 1 wt \%}{Tackifier 1 Softening Point} ) + ( \frac{Tackifier 2 wt \%}{Tackifier 2 Softening Point} ) + … ) \qquad ( I )$$

“Aromaticity” is the integration of aromatic protons versus an internal standard (1, 2 dichloroethane) given as weight percent of equivalent styrene, (104 g/mol). Aromaticity is determined by ¹HNMR spectroscopy and is measured in mol % of aromatic protons. Aromaticity of a blend of one or more tackifiers is calculated by formula II, as described by Fox. T. G., Flory, P. J. in Second-Order Transition Temperatures and Related Properties of Polystyrene, Journal of Applied Physics 21, 581-591 (1950).

Tackifier Blend Aromaticity=Σ((Tackifier1 wt %×Tackifier1 Aromaticity)+(Tackifier2 wt %×Tackifier2 Aromaticity)+ . . . ) (II)

“Cloud Point” of the one or more tackifiers is the temperature at which one or more tackifiers, dissolved in particular solvent, is no longer completely soluble (as determined by a cloudy appearance of the tackifier/solvent mixture). The Cloud Point of the present invention was determined using a modified ASTM D-611-82 method, substituting methylcyclohexane for the heptane used in the standard test procedure. The procedure used tackifier/aniline/methylcyclohexane in a ratio of about 1/2/1 (5 g/10 mL/5 mL). The Cloud Point was determined by cooling a heated, clear blend of the three components until a complete turbidity occurs.

The present invention includes newly designed tackifiers prepared according to methods known in the industry. Four grades of tackifiers (referred to herein as Tackifiers A-D, E-G, H-K, and L-N) were prepared by varying the feed stream in a thermal polymerization unit known in the art to achieve a certain tackifier cloud point. Tackifiers A-D had a Cloud Point of about 43° C. Tackifiers E-G had a Cloud Point of about 45° C., Tackifiers H-K had a Cloud Point of about 50° C., and Tackifiers L-N had a Cloud Point of about 46° C. After processing in the thermal polymerization unit, the tackifiers were Nitrogen-stripped at 200° C. Each grade of tackifier was subjected to different stripping conditions to achieve a target softening point, resulting in four uniquely designed tackifiers for each grade, totaling sixteen tackifiers. The properties of the newly designed tackifiers are provided in Table 2.

The resins described above may be produced by methods generally known in the art for the production of hydrocarbon resins. See for example, the Kirk-Othmer Encyclopedia of Chemical Technology, 4th ed., Vol. 13, pp. 717-744. A preferred method for production of the resins described above is by thermally or catalytically polymerizing petroleum fractions. These polymerizations may be batch, semi-batch or continuous. Petroleum fractions containing aliphatic C₅ to C₆ linear, branched, alicyclic monoolefins, diolefins, alicyclic C₁₀ diolefins can be polymerized. The aliphatic olefins can comprise one or more natural or synthetic terpenes, preferably one or more of alpha-pinene, beta-pinene, delta-3 carene, dipentene, limonene or isoprene dimers. C₈-C₁₀ aromatic olefinic streams containing styrene, vinyl toluenes, indene, methyl-indenes can also be polymerized as such or in mixture with the aliphatic streams.

Thermal polymerization is usually carried out at a temperature between 160° C. and 320° C., e.g., at about 250° C., for a period of 0.5 to 9 hours, typically 1.5 to 4 hours.

The polymeric resin so produced is dissolved in an inert, de-aromatized or non-de-aromatized hydrocarbon solvent such as Exxsol™ or Varsol™ or base White spirit in proportions varying from 10% to 60% and preferably in the region of 30% by weight polymer. Hydrogenation is then conducted in a fixed-bed, continuous reactor with the feed flow being either an upflow or downflow liquid phase or trickle bed operation.

Hydrogenation treating conditions generally include reactions ranging in temperature of from about 100° C. to about 350° C., preferably ranging from about 150° C. to about 300° C., more preferably ranging from about 160° C. to about 270° C. The hydrogen pressure within the reactor should not exceed more than 2000 psi, preferably no more than 1500 psi, and most preferably no more than 1000 psi. The hydrogenation pressure is, however, a function of the hydrogen purity and the overall reaction pressure should be higher if the hydrogen contains impurities to give the desired hydrogen pressure. Typically the optimal pressure used is between about 750 psi and 1500 psi, preferably between about 800 psi and about 1000 psi. The hydrogen to feed volume ratio to the reactor under standard conditions (25° C., 1 atm pressure) typically can range from about 20 to about 200. Further description of exemplary methods for preparing the tackifiers described herein may be found in U.S. Pat. No. 6,433,104, which is incorporated by reference herein.

### D. Additives: Wax, Antioxidant, Fillers, Rheology Improvers

The HMA composition can include other additives, e.g., plasticizers, waxes, antioxidants, fillers, rheology improvers, and combinations thereof either alone or in combination with one or more tackifiers disclosed herein. The HMA composition can also include one or more polymer additives, either alone or in combination with one or more plasticizers, waxes, or antioxidants, fillers, rheology improvers, and combinations thereof as disclosed herein.

The term “antioxidant” is used herein to refer to high molecular weight hindered phenols and multifunctional phenols. A useful commercially available antioxidant is Irganox™ 1010. Irganox 1010 is a hindered phenolic antioxidant available from BASF SE Corporation located in Ludwigshafen, Germany. The invention is not limited to Irganox 1010 as the antioxidant. In embodiments, other antioxidants that may be used with the polymer blends of the invention, including, but are not limited to amines, hydroquinones, phenolics, phosphites, and thioester antioxidants.

The term “wax” is used herein to refer to a substance that adjusts the overall viscosity of the adhesive composition. The primary function of wax is to control the set time and cohesion of the adhesive system. Adhesive compositions of the present invention may comprise paraffin (petroleum) waxes and microcrystalline waxes. In embodiments, the adhesive compositions may have no wax. In embodiments, other waxes may be used with the polymer blends of the invention including, but not limited to, Castor Oil derivatives (HCO-waxes), ethylene co-terpolymers, Fisher-Tropsch waxes, microcrystalline, paraffin, polyolefin modified, and polyolefin. Useful commercially available waxes include, but are not limited to, Polywax™ 2000 and Polywax™ 3000 available from Baker Hughes.

The term “functionalized polyolefin” is used herein to refer to maleic anhydride-modified polypropylene and maleic anhydride-modified polypropylene wax. A useful commercially available functionalized polyolefin is Honeywell. AC™-596. AC-596 is polypropylene-maleic anhydride copolymer from Honeywell. Generally, the functionalized polyolefin is present in the adhesive composition in the amount of not greater than about 5 wt %. The use of a functionalized polyolefin in the present invention is not preferred given that use of such compounds is known to result in a yellowing/discoloration of the adhesive and is also subject to food regulations in parts of Europe.

The HMA composition can include additives known in the art as “fillers” and/or “rheology improvers” to reduce sagging in the final woodworking application. The use of fillers and/or rheology improvers can also serve to reduce costs associated with preparing HMA formulations as the polymer blend loading of such formulations can be lowered. Preferred fillers include silicates, ceramics, glass, quartz, mica, titanium dioxide, graphite, talcum, calcium carbonates, barium sulfate, silica, glass beads, mineral aggregates, clays, or carbon black. Suitable rheology improvers imparting thixotropy or sag resistance are, for example, organically modified clays, pyrogenic (fumed) silicas, urea derivatives and fibrillated or pulp chopped fibers. The polymer blend of the HMA of the present invention is present in the amount of about 75 wt % to about 95 wt % of the adhesive composition, wherein the adhesive composition does not contain any filler and/or rheology improver. In an embodiment of the present invention, one or more fillers and/or rheology improvers may be added. In such an embodiment, the polymer blend of the HMA will be present in the amount of about 50 to about 95 wt % of the adhesive composition. Preferably, the polymer blend will be present in the HMA, wherein the HMA contains one or more fillers and/or rheology improvers, within the range of about 50 wt % or 55 wt % or 60 wt % or 65 wt % or 70 wt % or 75 wt % or 80 wt % or 85 wt % to less than about 90 wt % or 95 wt % of the adhesive composition.

The HMA composition of the present invention can optionally include one or more amorphous poly-alpha-olefins or “APAO.” Useful commercially available APAOs include REXtac® available from Hunstman and Vestoplast® available from Degussa. In an embodiment, the HMA composition of the present invention can include one or more crystalline polypropylenes. A useful commercially available crystalline polypropylene is Achiever™ available from ExxonMobil Chemical.

### E. Applications of Polyolefin Adhesive Compositions

### Packaging

The adhesive formulations disclosed herein can be used in various packaging articles. The packaging article may be useful as a carton, container, crate, case, corrugated case, or tray, for example. More particularly, the packaging article may be useful as a cereal product, cracker product, beer packaging, frozen food product, paper bag, drinking cup, milk carton, juice carton, drinking cup, or as a container for shipping produce. The packaging article is formed by applying an adhesive composition to at least a portion of one or more packaging elements. The packaging elements may be formed from paper, paperboard, containerboard, tagboard, corrugated board, chipboard, kraft, cardboard, fiberboard, plastic resin, metal, metal alloys, foil, film, plastic film, laminates, sheeting, or any combination thereof. In one aspect, the adhesive composition may be used to bind or bond two or more packaging elements together wherein the packaging elements are formed from the same or different type of materials. Accordingly, the packaging elements may be individually formed from paper, paperboard, containerboard, tagboard, corrugated board, chipboard, kraft, cardboard, fiberboard, plastic resin, metal, metal alloys, foil, film, plastic film, laminates, sheeting, or any combination thereof. The one or more packaging elements may also be individually coated using paper, foil, metal, metal alloys, polyethylene, polypropylene, polyester, polyethylene terephthalate, polyvinyl chloride, polyvinylidine chloride, polyvinyl acetate, polyamides, homopolymers thereof, and combinations and copolymers thereof.

### Woodworking/Assembly

The adhesive formulations disclosed herein can be used in various woodworking applications including, but not limited to furniture (e.g., edge banding, profile wrapping), toys, musical instruments, window frames and sills, doors, flooring, fencing, tools, ladders, sporting goods, dog houses, gazebos/decks, picnic tables, playground structures, planters, scaffolding planks, kitchen utensils, coffins, church pews/altars, and canes. The adhesive formulations described herein, having a high polymer load, provide a desired combination of physical properties such as stable adhesion over time, indicative of broad application temperature ranges, and a long open time and therefore can be used in a variety of woodworking applications disclosed herein. It should be appreciated that the adhesive formulations of the present disclosure, while being well suited for use in woodworking products, may also find utility in other applications as well.

In a particular embodiment, a woodworking process to prepare the woodworking application involves forming a woodworking article by applying an adhesive composition to at least a portion of a structural element. The structural element can include a variety of materials, which include, but are not limited to wood or plywood, or plastic or veneer. For example, the structural element can also include lumber, wood, fiberboard, plasterboard, gypsum, wallboard, plywood, PVC, melamine, polyester, impregnated paper and sheetrock. A woodworking process can be used to form indoor furniture, outdoor furniture, trim, molding, doors, sashes, windows, millwork and cabinetry, for example.

### Examples

“Peel” is a measure of the amount of a substrate that remains bonded to the HMA after the substrate is manually peeled from the HMA. Peel is measured in %. In the present invention, Peel was measured by the following method. A 3 cm×7 cm portion of the substrate Alkorcell #5 was cut. Alkorcell is pattern foil used for facing chipboards for furniture production, edging, user electronics, ceiling panels, elements for interior doors. 0.3 g of molten HMA composition was placed on a 5 cm×13 cm wooden plate. The substrate was bonded to the wooden plate via the molten HMA. To ensure good adhesion, a 2 kg weight was placed on the bonded area for 1 minute. The bonded samples were stored at room temperature for 24 hours and manually peeled by hand. Another set of samples were stored at 6° C. for 24 hours and manually peeled by hand. The amount of substrate that remains bonded to the HMA after the substrate is manually peeled from the HMA was recorded as the Peel at Room Temperature and as the Peel at 6° C., respectively. As used herein, the term “Room Temperature” is used to refer to the temperature range of about 20° C. to about 23.5° C. A Peel of 100% means that all of the substrate remained bonded to the HMA, indicating a strong adhesive bond. “Open time” is determined by coating an adhesive on a first substrate to form a coated first substrate, applying a second substrate to the coated first substrate at various intervals: 5 seconds, 10 seconds, 15 seconds, and 20 seconds, and placing a 100 g weight on the bonded area of the second substrate for 1 minute. Peel was also measured and related to various intervals: after 5 seconds, after 10 seconds, after 15 seconds, and after 20 seconds of bonding.

“Peel Adhesion Failure Temperature” or “PAFT” is defined as the temperature at which the adhesive bond of the composition fails. PAFT of a hot melt adhesive composition is tested according to the standard PAFT test based on ASTM D-4498. PAFT is a critical factor for storing boxes in environments above ambient temperature, such as warehouses. PAFT is measured in ° C. In the present invention, preferably the PAFT is 60° C. or higher.

“Shear Adhesion Failure Temperature” or “SAFT” is defined as the temperature at which the adhesive bond of the composition fails when the bond is subjected to a stepwise temperature increase under a constant force that pulls the bond in the shear mode. In the present invention, SAFT was measured by the following method. A 12 g sample of HMA was placed in a square mold (15 cm×15 cm) 200-micron thick and put between two silicon papers in a press operated at 160° C. The press can be operated by the following procedure: a 7 minute preheating step, a 7 minute degassing step, a 30 second pressurizing step at 100 kN, and a cooling step using plates operated at room temperature for 30 seconds at 100 kN pressure. As used herein, the term “Room Temperature” is used to refer to the temperature range of about 20° C. to about 23.5° C. A 2 cm×2 cm area of HMA cut from the HMA preparation plate was placed on a 2.5 cm×8 cm wood sample in an oven for 5 minutes at 190° C. A 2.2 cm×7 cm strip of wood laminate substrate was placed on top of the molten HMA. To ensure a good adhesion, a 2 kg weight was placed on the bonded area for 1 minute. After a conditioning for 24 hours at 23° C. and 50% Relative Humidity, the test specimens were suspended vertically in an oven at 50° C. with a 1 kg load attached to the bottom and were held for 1 hour. The temperature of the oven was increased by 10° C. during 5-minute intervals, after which the specimen was held for 55 minutes at this temperature. The temperature was gradually increased until the bond failed, at which point the temperature and time were recorded. Adhesives possessing high failure temperature are essential for the assembly of woodworking goods that are often subjected to very high temperatures when exposed to sunlight, e.g., furniture positioned next to a window. Generally, the SAFT of the HMA of the present invention ranges from about 70° C. to about 120° C. Preferably, the SAFT is within the range of about 80° C. or 90° C. or 100° C. or 110° C. to less than about 120° C.

“Set Time” is the minimum time interval, after bonding two substrates, during which the cohesive strength of the bond becomes stronger than joint stress. It represents the time necessary to cool down an adhesive composition and obtain a good bond. Set time is determined by bonding together substrates with the adhesive after the molten adhesive (180° C.) has been dropped onto one of the substrates with an eye dropper. The second substrate is placed on top of the adhesive, and a 500 g weight is placed on top of the second substrate for even application. After a predetermined interval of time, the second substrate is removed and checked for fiber tear. If no fiber tear is found, a longer interval of time is tried. This is continued until fiber tear is found. This length of time is reported as the set time in seconds.

“Fiber Tear” describes the bond strength of the adhesive to the substrate and is measured at room temperature, refrigerator temperature (temperature noted in the respective table), and −18° C. (freezer temperature). Fiber tear is a visual measurement as to the amount of paper substrate fibers that are attached to a bond after the substrates are torn apart. 100% fiber tear means the adhesive is stronger than the substrate and 100% of the adhesive is covered in substrate fibers. Fiber tear is determined by bonding together substrates with the adhesive. A drop of molten adhesive (180° C.) is positioned on one of the substrates. The second substrate is placed on top of the adhesive, and a 500 g weight is placed on top of the second substrate for even application. The adhesive is cooled at the referenced temperature for at least one hour. The substrates are then torn apart and the adhesive is inspected for fiber tear. In the present invention, fiber tear of at least 60% is desired. Preferably, the fiber tear is greater than 90%.

“Failure Mode” is defined as whether the adhesive bonds or fails when used to adhere a substrate to an inland board. Failure mode is determined at room temperature, 2° C. (refrigerator temperature), and −18° C. (freezer temperature). AF indicates adhesive failure with clean separation of the substrate from the inland board when the substrate is adhered on the hotside of the board. AT indicates adhesive transfer with clean separation of the substrate from the inland board when the substrate is adhered on the cold side of the board. Where the hot side and cold side of the inland board are identical in nature, AT can be reported as AF. FT indicates fiber tear when the adhesive damages the substrate surface. ST indicates substrate tear when the substrate gets tom during test. SF indicates substrate failure or separation of the corrugated. CF indicates cohesive failure when the adhesive splits and residue remains on both the hot side and cold side of the inland board. AB indicates adhesive break when the adhesive cracks with partial adhesive transfer. AB/AF indicates adhesive break plus adhesive failure where the adhesive cracks when the substrate is adhered on the hot side of the board. AB/AT indicates adhesive break plus adhesive transfer where the adhesive cracks when the substrate is adhered on the cold side of the board. CB/AB indicates cohesive or adhesive break where there is a brittle shattering of the adhesive. For CB, the remaining shattered adhesive is on both sides of the board. For AB, the remaining shattered adhesive is on one side. Typically, 5 cardboard specimens are glued together, allowed to cool, pulled apart and the average percent fiber tear is recorded. Where there is more than one mode of failure each mode is listed, e.g., 3AB, 2FT indicates 3 of the 5 specimens had adhesive break while 2 of the 5 specimens showed fiber tear.

To apply the adhesive to the substrate, one or more polymer blends, optionally with other additives, including one or more tackifiers, one or more plasticizers, one or more waxes, and one or more antioxidants, is preheated at the application temperature until the polymer is molten. The molten material is poured into a hot melt tank and allowed to equilibrate. The pump speed is set and the add-on is calculated based on the amount of adhesive that passes through the nozzle in a given time.

In a pilot plant, propylene-ethylene copolymers are produced by reacting a feed stream of propylene with a feed stream of ethylene in the presence of a metallocene catalyst. The adhesive blends presented in the Tables below are prepared by preheating the blend of one or more tackifiers, plasticizers, waxes, and an antioxidant to 177° C. One or more polymer blends is slowly added in a heated mantle at 177° C. to the molten liquid of tackifier, plasticizer, wax, and antioxidant until all of the polymer has been added and is completely blended. The components are blended by manual stirring using a spatula until all polymer pellets are melted and the mixture is homogeneous. The components are stirred for an additional 10 minutes. The adhesive blend is removed from the heating mantle, and poured onto release paper. After the adhesive blend solidifies, it is cut into small pieces for testing.

The polymer blends used in the examples of the invention are listed in Table 1 and were generally produced in accordance with the method disclosed in International Publication No. 2013/134038. As used in Table 1, the term “bimodal” refers to a polymer blend having more than one compositional peak when measured by GPC. The invention is not limited to the polymer blends of Table 1. The comparative example (referred to herein as Comparative or Control) is the commercially available premium grade of hot melt adhesives for use in packaging applications by H.B. Fuller: Advantra® PHC9256.

Table 2 shows fifteen inventive adhesive formulations having Polymer Blend B, 5 wt % wax, 15 wt % of the newly designed tackifier (Tackifier A to N prepared according to the method described above), and an antioxidant. Physical testings of the formulations were performed to determine the set time, fiber tear and failure mode (at various temperatures), and PAFT. Formulation 2A, having Tackifier B, displayed favorable PAFT above 60° C. without compromising fiber tear, as compared to the rest of the formulations in Table 2. Table 2 also shows comparative formulations: Formulation 16A, 17A, and 18A (Advantra® PHC9256). Inventive formulation 2A displayed slightly higher set time than the comparative. Table 2 indicates the effect of the selection of tackifier (based on the Aromaticity, Softening Point, and Cloud Point) to achieve the target adhesive physical properties of set time, fiber tear, and PAFT.

Table 3 shows the effect of increasing the amount of wax on the adhesive formulation properties. Four adhesive formulations having Polymer Blend B, Tackifier B, 7.5 wt % wax (2.5 wt % more wax than the formulations of Table 2), and an antioxidant are shown. The physical testings of all formulations indicate improved PAFT, set time, and fiber tear in comparison to formulation 2A of Table 2. While Table 3 evaluated the effect of the wax content on an adhesive formulation with Tackifier B (varying the wax content in Formulations 1B and 2B and the tackifier amount in Formulations 1B and 2B as compared to 3B and 4B), it is expected that similar trends would be achievable with any of the tackifiers (A and C-N) listed in Table 2. Table 3 indicates the effect of marginally increasing the wax content in the formulation to achieve the target adhesive physical properties.

Table 4 shows 17 formulations having Polymer Blend C, various blends of commercial tackifiers, an antioxidant, and a functionalized polyolefin. All formulations were tested for adhesive viscosity, SAFT, and peel. Formulations 1C, 2C, 7C, 8C, and 9C displayed favorable SAFT without compromising peel time at various testing intervals. Table 4 also shows the physical properties when the formulation is modified by decreasing the polymer content by 10 wt %, increasing the tackifier content by 10 wt %, using a wax—namely Polywax™2000 in place of a functionalized polyolefin, and decreasing the amount of antioxidant. Such changes in the formulation generally resulted in satisfactory SAFT and open time properties, however not being as favorable as those seen in the initial formulations. The use of a functionalized polyolefin in the present invention is not preferred given that use of such compounds is known to result in a yellowing/discoloration of the adhesive and is also subject to food regulations in parts of Europe.

Table 5 shows 14 formulations having Polymer Blend D, functionalized polyolefin, an antioxidant, and one of the newly designed tackifiers (Tackifier A-I and K-N prepared according to the method described above). All formulations displayed favorable SAFT measurements. Table 5 also shows the SAFT measurement when the formulation is modified by increasing the tackifier by 5 wt % in place of the functionalized polyolefin. Such a change in the formulation generally resulted in satisfactory SAFT, however slightly lower than those seen in the initial formulations. Table 5 shows that including the newly designed tackifiers in the formulations improves the open time of the formulations with a slight improvement in SAFT, as compared to formulations having conventional tackifiers without the functionalized polyolefin. Accordingly, the present invention provides a solution for reducing or replacing the use of a functionalized polyolefin in place of one or more of the newly designed tackifiers to achieve favorable adhesive properties.

Table 6 shows the effect of the selection of wax on the physical properties of the adhesive formulation. Specifically, Table 6 shows 32 formulations having Polymer Blend A, a selection of wax, one or more commercial tackifiers, and an antioxidant. The formulations were tested for fiber tear, failure mode, and set time. As compared to the Control, many formulations displayed more favorable fiber tear at all temperature testings and shorter set time. Generally, formulations having Sasolwax H1 displayed poor physical properties and formulations having Polywax™3000 or Paravan™158 displayed good fiber tear. Formulations having C80 displayed favorable fiber tear based on the selection of the tackifier. Formulations having Polywax™3000 displayed good set time as compared to the Control. Table 6 shows that the selection of the wax effects the fiber tear at low temperature as well as the set time.

Table 7 shows the effect of the selection of amount and type of polymer on the physical properties of the adhesive formulation. Specifically, Table 7 shows 5 formulations having a selection of one of three polymers, a commercial wax, an antioxidant, and a selection of novel tackifiers. The formulations were tested for fiber tear, failure mode, set time, and PAFT. As compared to the Control, formulations 1F and 2F displayed favorable set time but at lowered PAFT and reduced fiber tear values. Table 7 shows that the selection of the polymer effects the adhesive properties.

Table 8 shows the effect of the selection of commercial tackifier on the physical properties of the adhesive formulation. Specifically, Table 8 shows 30 formulations having a selection of Polymer Blend A, one or more waxes, one or more commercial tackifiers, and an antioxidant. The formulations were tested for fiber tear, failure mode, set time, and physical appearance. Table 8 also reports the softening point and aromaticity of the one or more tackifiers used in the respective formulation.

Certain embodiments and features have been described using a set of numerical upper limits and a set of numerical lower limits. It should be appreciated that ranges from any lower limit to any upper limit are contemplated unless otherwise indicated. Certain lower limits, upper limits, and ranges appear in one or more claims below. All numerical values are “about” or “approximately” the indicated value, and take into account experimental error and variations that would be expected by a person having ordinary skill in the art.

To the extent a term used in a claim is not defined above, it should be given the broadest definition which persons in the pertinent art have given, as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

TABLE 1

| | Viscosity | DSC | | | DSC | |
|---|---|---|---|---|---|---|
| Polymer | at 190° C., | Crystallinity, | Shore | Ethylene | Melting | Bi- |
| Blend | cP | dH, J/g | Hardness C | Content, % | Point, ° C. | modal |
| Polymer | 1,135 | 47 | 51 | 7.4 | 113 | Yes |
| Blend A | | | | | | |
| Polymer | 1,345 | 52 | 50 | 6.2 | 99 | Yes |
| Blend B | | | | | | |
| Polymer | 12,450 | 37 | 40 | 8.3 | 105 | Yes |
| Blend C | | | | | | |
| Polymer | 12,820 | 40 | 49 | 8.7 | 107 | Yes |
| Blend D | | | | | | |

TABLE 2

| | | Adhesive Formulation | | | Tackifier | | | |
|---|---|---|---|---|---|---|---|---|
| | Adhesive | | % Fiber Tear, | Avg. | | Softening | Cloud | |
| | Formulation | Set Time | Failure Mode | PAFT | Aromatic | Point | Point | Mn |
| | (wt % Adhesive) | (sec) | (Room Temp/2° C.) | (° C.) | mol. % | (° C.) | (° C.) | (g/mol) |
| 1A | 79.5 Polymer Blend B | 2.5 | 99/14, | 52 | 8.1 | 102 | 43 | 393 |
| | 5 Polywax ™2000 | | FT/AB; FT | | | | | |
| | 15 Tackifier A | | | | | | | |
| | 0.5 Irganox ™ 1010 | | | | | | | |
| 2A | 79.5 Polymer Blend B | 2-2.5 | 78/37, | 62 | 8.4 | 107 | 43 | 403 |
| | 5 Polywax ™2000 | | FT/FT | | | | | |
| | 15 Tackifier B | | | | | | | |
| | 0.5 Irganox ™ 1010 | | | | | | | |
| 3A | 79.5Polymer Blend B | 2.5 | 59/0, | 58 | 8.3 | 111 | 43 | 418 |
| | 5 Polywax ™2000 | | FT/AB | | | | | |
| | 15 Tackifier C | | | | | | | |
| | 0.5 Irganox ™ 1010 | | | | | | | |
| 4A | 79.5 Polymer Blend B | 2.3-2.5 | 100/8, | 55 | 8.4 | 114 | 43 | 428 |
| | 5 Polywax ™2000 | | FT/AB; AF | | | | | |
| | 15 Tackifier D | | | | | | | |
| | 0.5 Irganox ™ 1010 | | | | | | | |
| 5A | 79.5 Polymer Blend B | 2-2.5 | 56/16, | 55 | 9.7 | 98 | 45 | 401 |
| | 5 Polywax ™2000 | | FT/AB; AF | | | | | |
| | 15 Tackifier E | | | | | | | |
| | 0.5 Irganox ™ 1010 | | | | | | | |
| 6A | 79.5 Polymer Blend B | 2.7 | 32/0, | 58 | 9.7 | 103 | 45 | 415 |
| | 5 Polywax ™2000 | | 3AB; FT/AB | | | | | |
| | 15 Tackifier F | | | | | | | |
| | 0.5 Irganox ™ 1010 | | | | | | | |
| 7A | 79.5 Polymer Blend B | 2.3-2.5 | 52/2, | 56 | 9.6 | 107 | 45 | 426 |
| | 5 Polywax ™2000 | | FT/AB | | | | | |
| | 15 Tackifier G | | | | | | | |
| | 0.5 Irganox ™ 1010 | | | | | | | |
| 8A | 79.5 Polymer Blend B | 2.3-2.5 | 94/10, | 55 | 9.6 | 95 | 50 | 383 |
| | 5 Polywax ™2000 | | FT/AB | | | | | |
| | 15 Tackifier H | | | | | | | |
| | 0.5 Irganox ™ 1010 | | | | | | | |
| 9A | 79.5 Polymer Blend B | 2.5-2.7 | 87/0, | 56 | 9.6 | 99 | 50 | 393 |
| | Polywax ™2000 | | FT/AB | | | | | |
| | 15 Tackifier I | | | | | | | |
| | 0.5 Irganox ™ 1010 | | | | | | | |
| 10A | 79.5Polymer Blend B | 2.3-2.5 | 56/39, | 56 | 9.7 | 103 | 50 | 405 |
| | 5 Polywax ™2000 | | FT; 1AB/AB | | | | | |
| | 15 Tackifier J | | | | | | | |
| | 0.5 Irganox ™ 1010 | | | | | | | |
| 11A | 79.5 Polymer Blend B | 2.7-3 | 95/0, | 56 | 9.7 | 107 | 50 | |
| | 5 Polywax ™2000 | | FT/AB | | | | | |
| | 15 Tackifier K | | | | | | | |
| | 0.5 Irganox ™ 1010 | | | | | | | |
| 12A | 79.5Polymer Blend B | 2.7-3 | 44/12, | 53 | 9.8 | 95 | 46 | 380 |
| | 5 Polywax ™2000 | | FT/AB | | | | | |
| | 15 Tackifier L | | | | | | | |
| | 0.5 Irganox ™ 1010 | | | | | | | |
| 13A | 79.5Polymer Blend B | 2.3-2.5 | 57/0, | 55 | 9.7 | 101 | 46 | 392 |
| | 5 Polywax ™2000 | | FT/AB | | | | | |
| | 15 Tackifier M | | | | | | | |
| | 0.5 Irganox ™ 1010 | | | | | | | |
| 14A | 79.5Polymer Blend B | 2-2.3 | 57/0, | 59 | 9.8 | 104 | 46 | 405 |
| | 5 Polywax ™2000 | | FT/AN | | | | | |
| | 15 Tackifier N | | | | | | | |
| | 0.5 Irganox ™ 1010 | | | | | | | |
| 15A | 79.5 Polymer Blend B | — | 38/0, | 52 | 11 | 115 | 52 | 570 |
| | 5 Polywax ™2000 | | FT; 1AB/AB | | | | | |
| | 15 Escorez ™5615 | | | | | | | |
| | 0.5 Irganox ™ 1010 | | | | | | | |
| 16A | 79.5 Polymer Blend B | 1.5 | 93/0 | 40 | 8 | 90 | 50 | |
| | 5 Polywax ™2000 | | | | | | | |
| | 10 Escorez ™5690 | | | | | | | |
| | 4.5 Escorez ™5380 | | | | | | | |
| | 0.5 Irganox ™ 1010 | | | | | | | |
| 17A | 79.5 Polymer Blend B | 1-1.5 | 98/0 | 47 | 5 | 130 | 65 | 570 |
| | 5 Polywax ™2000 | | | | | | | |
| | 15 Escorez ™5637 | | | | | | | |
| | 0.5 Irganox ™ 1010 | | | | | | | |
| 18A | Control | 1.5 | 67/8, | 60 | 5 | 130 | 65 | 570 |
| | | | AB; FT/AB | | | | | |

TABLE 3

| | | | % Fiber Tear | | |
|---|---|---|---|---|---|
| | | | (Room Temp/ | | |
| | Adhesive Formulation | Set Time | −18° C./ | Failure Mode | PAFT |
| | (wt % of the Adhesive) | (sec) | 3° C.) | (Room Temp/3° C.) | (° C.) |
| 1B | 76.5 Polymer Blend B | 1.7-2.3 | 100/26/83 | FT/ | 77 |
| | 7.5 Polywax ™3000 | | | FT | |
| | 15 Tackifier B | | | | |
| | 0.5 Irganox ™ 1010 | | | | |
| 2B | 76.5 Polymer Blend B | 1.7-2.3 | 94/0/0 | AB; 4FT/ | 76 |
| | 7.5 Polywax ™2000 | | | AB | |
| | 15 Tackifier B | | | | |
| | 0.5 Irganox ™ 1010 | | | | |
| 3B | 79.5 Polymer Blend B | 1.5-1.7 | 100/5/81 | FT/ | 63 |
| | 7.5 Polywax ™3000 | | | 2AB; FT | |
| | 12.5 Tackifier B | | | | |
| | 0.5 Irganox ™ 1010 | | | | |
| 4B | 79.5 Polymer Blend B | 1.5-2 | 95/0/20 | FT/ | 60 |
| | 7.5 Polywax ™2000 | | | AB | |
| | 12.5 Tackifier B | | | | |
| | 0.5 Irganox ™ 1010 | | | | |

TABLE 4

| | | | | | | | | Peel after | | Viscosity, |
|---|---|---|---|---|---|---|---|---|---|---|
| | | | | | Peel | | | 5, 10, 15, 20 sec | SAFT, | at 190° C. |
| | Adhesive | Tackifier | | Tackifier | after | | | (%) | (° C.) | (cP) |
| | Formulation | Softening | Tackifier | Cloud | 5, 10, | | Viscosity, | (79.1 Polymer Blend C, 10 wt % | | |
| | (wt % of the | Point | Aromatic | Point | 15, 20 sec | SAFT, | at 190° C. | more tackifier, wax in place of | | |
| | Adhesive) | (° C.) | mol. % | (° C.) | (%) | (° C.) | (cP) | A-C ™596P) | | |
| 1C | 89.1 Polymer Blend C | 96 | 9.75 | 63 | 90, 70, | 100 | 10,806 | 70, 40, | 76 | 8,050 |
| | 2.5 Escorez ™5690 | | | | 20, 10 | | | 30, 0 | | |
| | 2.5 Escorez ™5600 | | | | | | | | | |
| | 0.9 Irganox ™1010 | | | | | | | | | |
| | 5 A-C ™596P | | | | | | | | | |
| 2C | 89.1 Polymer Blend C | 94 | 4.8 | 65 | 50, 30, | 102 | 10,900 | 90, 30, | 77 | 7,990 |
| | 2.5 Escorez ™5380 | | | | 20, 10 | | | 10, 0 | | |
| | 2.5 Escorez ™5600 | | | | | | | | | |
| | 0.9 Irganox ™1010 | | | | | | | | | |
| | 5 A-C ™596P | | | | | | | | | |
| 3C | 89.1 Polymer Blend C | 89 | 8.6 | 67 | 70, 60, | 104 | 10,675 | 80, 30, | 77 | 7,970 |
| | 4.3 Escorez ™5690 | | | | 40, 20 | | | 20, 10 | | |
| | 0.7 Escorez ™ 5380 | | | | | | | | | |
| | 0.9 Irganox ™1010 | | | | | | | | | |
| | 5 A-C ™596P | | | | | | | | | |
| 4C | 89.1 Polymer Blend C | 96 | 5.1 | 69 | 50, 40, | 102 | 10,838 | 70, 40, | 72 | 8,010 |
| | 2.5 Escorez ™5690 | | | | 20, 0 | | | 20, 10 | | |
| | 2.5 Escorez ™5400 | | | | | | | | | |
| | 0.9 Irganox ™1010 | | | | | | | | | |
| | 5 A-C ™596P | | | | | | | | | |
| 5C | 89.1 Polymer Blend C | 91 | 9.2 | 67 | 70, 40, | 100 | 11,100 | 70, 50, | 76 | 7,910 |
| | 4.6 Escorez ™5690 | | | | 30, 10 | | | 30, 20 | | |
| | 0.4 Escorez ™5400 | | | | | | | | | |
| | 0.9 Irganox ™1010 | | | | | | | | | |
| | 5 A-C ™596P | | | | | | | | | |
| 6C | 89.1 Polymer Blend C | 103 | 8.8 | 74 | 70, 20, | 101 | 11,000 | 70, 40, | 76 | 8,190 |
| | 0.4 Escorez ™5400 | | | | 10, 0 | | | 0, 0 | | |
| | 4.6 Escorez ™5600 | | | | | | | | | |
| | 0.9 Irganox ™1010 | | | | | | | | | |
| | 5 A-C ™596P | | | | | | | | | |
| 7C | 89.1 Polymer Blend C | 108 | 6.2 | 64 | 90, 70, | 102 | 10,900 | 80, 60, | 81 | 8,270 |
| | 1.75 Escorez ™5415 | | | | 60, 20 | | | 20, 10 | | |
| | 3.25 Escorez ™5600 | | | | | | | | | |
| | 0.9 Irganox ™1010 | | | | | | | | | |
| | 5 A-C ™596P | | | | | | | | | |
| 8C | 89.1 Polymer Blend C | 110 | 4.8 | 65 | 80, 80, | 100 | 11,013 | 80, 60, | 77 | 8,310 |
| | 2.5 Escorez ™5415 | | | | 70, 40 | | | 40, 10 | | |
| | 2.5 Escorez ™5600 | | | | | | | | | |
| | 0.9 Irganox ™1010 | | | | | | | | | |
| | 5 A-C ™596P | | | | | | | | | |
| 9C | 89.1 Polymer Blend C | 104 | 8.8 | 60 | 90, 90, | 101 | 11,050 | 90, 80, | 80 | 8,125 |
| | 0.4 Escorez ™5415 | | | | 60, 50 | | | 50, 10 | | |
| | 4.6 Escorez ™5600 | | | | | | | | | |
| | 0.9 Irganox ™1010 | | | | | | | | | |
| | 5 A-C ™596P | | | | | | | | | |
| 10C | 89.1 Polymer Blend C | 98 | 6.5 | 68 | 90, 50, 40, 10 | 102 | 10,812 | 70, 30, | 82 | 8,210 |
| | 3.25 Escorez ™5690 | | | | | | | 10, 10 | | |
| | 1.75 Escorez ™5415 | | | | | | | | | |
| | 0.9 Irganox ™1010 | | | | | | | | | |
| | 5 A-C ™596P | | | | | | | | | |
| 11C | 89.1 Polymer Blend C | 129 | 5.5 | 84 | 60, 40, 10, 0 | 105 | 11,625 | 70, 50, 20, 0 | 79 | 8,670 |
| | 0.4 Escorez ™5415 | | | | | | | | | |
| | 4.6 Escorez ™5637 | | | | | | | | | |
| | 0.9 Irganox ™1010 | | | | | | | | | |
| | 5 A-C ™596P | | | | | | | | | |
| 12C | 89.1 Polymer Blend C | 106 | 8 | 73 | 70, 60, 60, 40 | 103 | 11,187 | 50, 10, 0, 0 | 79 | 8,400 |
| | 2.5 Escorez ™5690 | | | | | | | | | |
| | 2.5 Escorez ™5637 | | | | | | | | | |
| | 0.9 Irganox ™1010 | | | | | | | | | |
| | 5 A-C ™596P | | | | | | | | | |
| 13C | 89.1 Polymer Blend C | 119 | 6.8 | 79 | 90, 60, 50, 0 | 102 | 11,200 | 40, 20, 20, 0 | 84 | 8,520 |
| | 1 Escorez ™5690 | | | | | | | | | |
| | 4 Escorez ™5637 | | | | | | | | | |
| | 0.9 Irganox ™1010 | | | | | | | | | |
| | 5 A-C ™596P | | | | | | | | | |
| 14C | 89.1 Polymer Blend C | 103 | 8.4 | 72 | 80, 70, 70, 40 | 97 | 10,925 | 70, 20, 10, 0 | 77 | 8,175 |
| | 3 Escorez ™5690 | | | | | | | | | |
| | 2 Escorez ™5415 | | | | | | | | | |
| | 0.9 Irganox ™1010 | | | | | | | | | |
| | 5 A-C ™596P | | | | | | | | | |
| 15C | 89.1 Polymer Blend C | 133 | 4.2 | 81 | 60, 50, 0, 0 | 103 | 11,025 | 60, 30, 0, 0 | 77 | 8,590 |
| | 3.5 Escorez ™5637 | | | | | | | | | |
| | 1.5 Oppera ™100N | | | | | | | | | |
| | 0.9 Irganox ™1010 | | | | | | | | | |
| | 5 A-C ™596P | | | | | | | | | |
| 16C | 89.1 Polymer Blend C | 95 | 8.6 | 67 | 60, 40, 10, 0 | 100 | 10,825 | 40, 30, 10, 0 | 80 | 8,150 |
| | 4.3 Escorez ™5690 | | | | | | | | | |
| | 0.7 Oppera ™100N | | | | | | | | | |
| | 0.9 Irganox ™1010 | | | | | | | | | |
| | 5 A-C ™596P | | | | | | | | | |
| 17C | 89.1 Polymer Blend C | 118 | 0.1 | | 80, 70, 10, 10 | 101 | 11,000 | — | — | — |
| | 5 Escorez ™5415 | | | | | | | | | |
| | 0.9 Irganox ™1010 | | | | | | | | | |
| | 5 A-C ™596P | | | | | | | | | |

TABLE 5

| | | | | | | | Peel after |
|---|---|---|---|---|---|---|---|
| | | Tackifier | | Tackifier | | SAFT, | 5, 10, 20 sec |
| | | Softening | Tackifier | Cloud | | (° C.) | (%) |
| | Adhesive Formulation | Point, | Aromatic | Point | SAFT, | (no A-C ™596P and | |
| | (wt % of the Adhesive) | (° C.) | mol % | (° C.) | (° C.) | 5% more tackifier) | |
| 1D | 89.1Polymer Blend D/5 Tackifier A/ | 103 | 8.1 | 43 | 98 | 85 | 20, 20, 0 |
| | 0.9 Irganox ™1010/5 A-C ™596P | | | | | | |
| 2D | 89.1Polymer Blend D/5 Tackifier B/ | 107 | 8.4 | 43 | 99 | 85 | 70, 30, |
| | 0.9 Irganox ™1010/5 A-C ™596P | | | | | | 10 |
| 3D | 89.1Polymer Blend D/5 Tackifier C/ | 111 | 8.3 | 43 | 97 | 82 | 70, 50, |
| | 0.9 Irganox ™1010/5 A-C ™596P | | | | | | 20 |
| 4D | 89.1Polymer Blend D/5 Tackifier D/ | 114 | 8.4 | 43 | 98 | 86 | 80, 50, |
| | 0.9 Irganox ™1010/5 A-C ™596P | | | | | | 20 |
| 5D | 89.1Polymer Blend D/5 Tackifier E/ | 99 | 9.7 | 45 | 98 | 74 | 40, 20, |
| | 0.9 Irganox ™1010/5 A-C ™596P | | | | | | 10 |
| 6D | 89.1Polymer Blend D/5 Tackifier F/ | 103 | 9.7 | 45 | 96 | 83 | 70, 20, 0 |
| | 0.9 Irganox ™1010/5 A-C ™596P | | | | | | |
| 7D | 89.1Polymer Blend D/5 Tackifier G/ | 107 | 9.6 | 45 | 98 | 79 | 70, 40, |
| | 0.9 Irganox ™1010/5 A-C ™596P | | | | | | 20 |
| 8D | 89.1Polymer Blend D/5 Tackifier H/ | 95 | 9.6 | 50 | 100 | 83 | 80, 50, |
| | 0.9 Irganox ™1010/5 A-C ™596P | | | | | | 20 |
| 9D | 89.1Polymer Blend D/5 Tackifier I/ | 100 | 9.6 | 50 | 97 | 82 | 80, 50, |
| | 0.9 Irganox ™1010/5 A-C ™596P | | | | | | 10 |
| 10D | 89.1Polymer Blend D/5 Tackifier K/ | 107 | 9.7 | 50 | 98 | 84 | 40, 20, 5 |
| | 0.9 Irganox ™1010/5 A-C ™596P | | | | | | |
| 11D | 89.1Polymer Blend D/5 Tackifier L/ | 95 | 9.8 | 46 | 96 | 82 | 90, 60, |
| | 0.9 Irganox ™1010/5 A-C ™596P | | | | | | 40 |
| 12D | 89.1Polymer Blend D/5 Tackifier M/ | 100 | 9.7 | 46 | 96 | 82 | 50, 20, |
| | 0.9 Irganox ™1010/5 A-C ™596P | | | | | | 10 |
| 13D | 89.1Polymer Blend D/5 Tackifier N/ | 104 | 9.8 | 46 | 96 | 86 | 90, 40, |
| | 0.9 Irganox ™1010/5 A-C ™596P | | | | | | 10 |
| 14D | 89.1Polymer Blend D/5 Escorez ™5615/ | 115 | 11 | 52 | 94 | 85 | 70, 40, |
| | 0.9 Irganox ™1010/5 A-C ™596P | | | | | | 10 |
| 15D | 89.1Polymer Blend D/ | 115 | 0 | | — | — | |
| | 0.9 Irganox ™1010/5 A-C ™596P | | | | | | |

TABLE 6

| | | % Fiber | | |
|---|---|---|---|---|
| | | Tear | | |
| | | (Room | Failure Mode | |
| | | Temp/ | (Room Temp/ | Set |
| | Adhesive Formulation | 6° C./ | 6° C./ | Time |
| | (wt % of the Adhesive) | −18° C.) | −18° C.) | (sec) |
| 1E | 79.5 Polymer Blend A/5 C80/ | 100/68/0 | FT/2AB; 3FT/AB; AF | 2.5 |
| | 7.5 Escorez ™5690/7.5 Escorez ™5380/0.5 Irganox ™1010 | | | |
| 2E | 79.5 Polymer Blend A/5 SasolwaxH1/ | 0/0/0 | AB/AB/AB; AF | 2-2.5 |
| | 7.5 Escorez ™5690/7.5 Escorez ™5380/0.5 Irganox ™1010 | | | |
| 3E | 79.5 Polymer Blend A/5 Polywax ™3000/ | 100/87/38 | FT/FT/FT; 2AB | 1-1.5 |
| | 7.5 Escorez ™5690/7.5 Escorez ™5380/0.5 Irganox ™1010 | | | |
| 4E | 79.5 Polymer Blend A/5 Paravan ™158/ | 100/88/80 | FT/FT/FT | 2.5-3 |
| | 7.5 Escorez ™5690/7.5 Escorez ™5380/0.5 Irganox ™1010 | | | |
| 5E | 79.5 Polymer Blend A/5 C80/ | 98/66/0 | AB; 4FT/AB/AB | 2.5 |
| | 7.5 Escorez ™5690/7.5 Escorez ™5380/0.5 Irganox ™1010 | | | |
| 6E | 79.5 Polymer Blend A/5 SasolwaxH1/ | 8/0/0 | AB; 2FT/AB/AB | 2-2.5 |
| | 7.5 Escorez ™5690/7.5 Escorez ™5380/0.5 Irganox ™1010 | | | |
| 7E | 79.5 Polymer Blend A/5 Polywax ™3000/ | 100/9762 | FT/AB; 4FT/AB | 1-1.5 |
| | 7.5 Escorez ™5690/7.5 Escorez ™5380/0.5 Irganox ™1010 | | | |
| 8E | 79.5 Polymer Blend A/5 Paravan ™158/ | 100/100/98 | FT/FT/FT | 3.5 |
| | 7.5 Escorez ™5690/7.5 Escorez ™5380/0.5 Irganox ™1010 | | | |
| 9E | 79.5 Polymer Blend A/5 C80/ | 0/0/0 | AB/AB/AB | 1.5 |
| | 14 Escorez ™2520/1 Escorez ™5400/0.5 Irganox ™1010 | | | |
| 10E | 79.5 Polymer Blend A/5 SasolwaxH1/ | 18/0/0 | AB/AB/AB | 2-2.5 |
| | 14 Escorez ™2520/1 Escorez ™5400/0.5 Irganox ™1010 | | | |
| 11E | 79.5 Polymer Blend A/5 Polywax ™3000/ | 100/93/36 | FT/FT/3AB; 2FT | 1.5 |
| | 14 Escorez ™2520/1 Escorez ™5400/0.5 Irganox ™1010 | | | |
| 12E | 79.5 Polymer Blend A/5 Paravan ™158/ | 100/100/99 | FT/FT/FT | 3.5-4 |
| | 14 Escorez ™2520/1 Escorez ™5400/0.5 Irganox ™1010 | | | |
| 13E | 79.5 Polymer Blend A/5 C80/ | 100/39/16 | FT/FT/AB | 2-2.5 |
| | 14.5 Escorez ™2520/0.5 Escorez ™5415/0.5 Irganox ™1010 | | | |
| 14E | 79.5 Polymer Blend A/5 SasolwaxH1/ | 44/0/0 | AB; 2FT/AB/AB | 1.5-2 |
| | 14.5 Escorez ™2520/0.5 Escorez ™5415/0.5 Irganox ™1010 | | | |
| Control | Advantra ®PHC9256 | 86/28/0 | AB; FT/AB/AB | 1-1.5 |
| 15E | 79.5 Polymer Blend A/5 Polywax ™3000/ | 100/73/13 | FT/FT/2AB; FT; 2AF | 1-1.5 |
| | 14.5 Escorez ™2520/0.5 Escorez ™5415/0.5 Irganox ™1010 | | | |
| 16E | 79.5 Polymer Blend A/5 Paravan ™158/ | 100/100/31 | FT/FT/3AB; 3FT | 3-3.5 |
| | 14.5 Escorez ™2520/0.5 Escorez ™5415/0.5 Irganox ™1010 | | | |
| 17E | 79.5 Polymer Blend A/5 C80/ | 100/75/0 | 2AB; 3FT/2AF; 3FT/AB | 2-2.5 |
| | 5.5 Escorez ™5415/9.5 Escorez ™5690/0.5 Irganox ™1010 | | | |
| 18E | 79.5 Polymer Blend A/5 SasolwaxH1/ | 47/0/0 | 3AB; 2FT/AB/AB | 2-2.5 |
| | 5.5 Escorez ™5415/9.5 Escorez ™5690/0.5 Irganox ™1010 | | | |
| 19E | 79.5 Polymer Blend A/5 Polywax ™3000/ | 100/93/25 | FT/FT/3AF; AB; 2FT | 1.5-2 |
| | 5.5 Escorez ™5415/9.5 Escorez ™5690/0.5 Irganox ™1010 | | | |
| 20E | 79.5 Polymer Blend A/5 Paravan ™158/ | 100/100/93 | FT/FT/FT | 4 |
| | 5.5 Escorez ™5415/9.5 Escorez ™5690/0.5 Irganox ™1010 | | | |
| 21E | 79.5 Polymer Blend A/5 C80/ | 100/65/0 | FT/2AB; 3FT/AB | 2.5-3 |
| | 6 Escorez ™5637/9 Escorez ™5690/0.5 Irganox ™1010 | | | |
| 22E | 79.5 Polymer Blend A/5 SasolwaxH1/ | 96/0/0 | FT/AB/4AB; 1FT | 2.5 |
| | 6 Escorez ™5637/9 Escorez ™5690/0.5 Irganox ™1010 | | | |
| 23E | 79.5 Polymer Blend A/5 Polywax ™3000/ | 100/98/62 | FT/FT/2AB; 3FT | 1.5-2 |
| | 6 Escorez ™ 5637/9 Escorez ™5690/0.5 Irganox ™1010 | | | |
| 24E | 79.5 Polymer Blend A/5 Paravan ™158/ | 100/100/82 | FT/FT/2AB; 3FT | 4.5+ |
| | 6 Escorez ™5637/9 Escorez ™5690/0.5 Irganox ™1010 | | | |
| 25E | 79.5 Polymer Blend A/5 C80/ | 92/0/0 | 3FT; 2AB/AB/AB | 2.5-3 |
| | 12 Escorez ™5637/3 Oppera ™100N/0.5 Irganox ™1010 | | | |
| 26E | 79.5 Polymer Blend A/5 SasolwaxH1/ | 12/0/0 | AB/AB/AB | 2-2.5 |
| | 12 Escorez ™5637/3 Oppera ™100N/0.5 Irganox ™1010 | | | |
| 27E | 79.5 Polymer Blend A/5 Polywax ™3000/ | 97/96/47 | FT/FT/3AB; 2FT | 1.5-2 |
| | 12 Escorez ™5637/3 Oppera ™100N/0.5 Irganox ™1010 | | | |
| 28E | 79.5 Polymer Blend A/5 Paravan ™158/ | 100/100/83 | FT/FT/FT | 4.5+ |
| | 12 Escorez ™5637/3 Oppera ™100N/0.5 Irganox ™1010 | | | |
| 29E | 79.5 Polymer Blend A/5 C80/ | 96/92/0 | FT/AB/AB | 2.5-3 |
| | 2 Oppera ™100N/13 Escorez ™5690/0.5 Irganox ™1010 | | | |
| 30E | 79.5 Polymer Blend A/5 SasolwaxH1/ | 58/0/0 | AB; FT/AB/AB | 1.5-2 |
| | 2 Oppera ™100N/13 Escorez ™5690/0.5 Irganox ™1010 | | | |
| 31E | 79.5 Polymer Blend A/5 Polywax ™3000/ | 98/93/74 | FT/FT/FT | 1-1.5 |
| | 2 Oppera ™100N/13 Escorez ™5690/0.5 Irganox ™1010 | | | |
| 32E | 79.5 Polymer Blend A/5 Paravan ™158/ | 100/100/99 | FT/FT/FT | 4-4.5 |
| | 2 Oppera ™100N/13 Escorez ™5690/0.5 Irganox ™1010 | | | |
| Control | Advantra ®PHC9256 | 86/28/0 | AB; FT/AB/AB | 1-1.5 |

TABLE 7

| | | % Fiber | | | |
|---|---|---|---|---|---|
| | | Tear | | | |
| | | (Room | | | |
| | | Temp/ | Failure Mode | Set | |
| | Adhesive Formulation | 3° C./ | (Room | Time | PAFT |
| | (wt % of the Adhesive) | −18° C.) | Temp/3° C.) | (sec) | (° C.) |
| 1F | 35 Escorene ™7520/25 Sasolwax H1/ | 26/0/0 | 2FT; 4AB/AB | 1 | 59 |
| | 39 Tackifier B/1 Irganox ™1010 | | | | |
| 2F | 35 Affinity GA 1950/25 Sasolwax H1/ | 98/22/0 | FT/4AB; FT | 1 | 53 |
| | 39 Tackifier B/1 Irganox ™1010 | | | | |
| 3F | 77 Polymer Blend A/7.5 Polywax ™3000/ | 95/38/0 | FT/FT; AB | 1.7-2 | 57 |
| | 15 Tackifier B/0.5 Irganox ™1010 | | | | |
| 4F | 77 Polymer Blend A/7.5 Polywax ™3000/ | 99/39/0 | FT/AB; 2FT | 1.7-2 | 59 |
| | 15 Tackifier N/0.5 Irganox ™1010 | | | | |
| 5F | 79.5 Polymer Blend A/7.5 Polywax ™3000/ | 98/73/0 | FT/FT | 2-2.3 | 44 |
| | 12.5 Tackifier N/0.5 Irganox ™1010 | | | | |
| Control | Advantra ®PHC9256 | 95/10/0 | AB/AB | 1.5 | 65 |

TABLE 8

| | | | | % Fiber | Failure | | |
|---|---|---|---|---|---|---|---|
| | | | | Tear | Mode | | |
| | | Tackifier | | (Room | (Room | | |
| | | Softenmg | Tackifier | Temp/ | Temp/ | Set | |
| | Adhesive Formulation | Point, | Aromatic | 2° C./ | 2° C./ | Time | |
| | (wt % of the Adhesive) | (° C.) | mol % | −18° C.) | −18° C.) | (sec) | Appearance |
| 1G | 79.5 Polymer Blend A/ | 100 | 9 | 11/0/0 | AB/AB/ | 2.5-3 | Clear |
| | 5 Polywax ™2000/15 Regalite C6100/ | | | | AB | | |
| | 0.5 Irganox ™ 1000 | | | | | | |
| 2G | 79.5 Polymer Blend A/ | 105 | 7 | 0/0/0 | AF/AB/ | 2-2.5 | Clear |
| | 5 Polywax ™ 2000/3.75 H130W/ | | | | AB | | |
| | 11.25 Regalite C6100/ | | | | | | |
| | 0.5 Irganox ™1010 | | | | | | |
| 3G | 79.5 Polymer Blend A/ | 105 | 6 | 0/0/0 | AF/AB/ | 2.3-2.5 | Clear |
| | 5 Polywax ™2000/6 Eastotac C115W/ | | | | AB | | |
| | 9 Regalite C6100/0.5 Irganox ™ 1010 | | | | | | |
| 4G | 79.5 Polymer Blend A/ | 115 | 6 | 18/0/0 | AB/AB/ | 2-2.5 | Clear |
| | 5 Polywax ™2000/7.5 H130W/ | | | | AB | | |
| | 7.5 Regalite S5100/ | | | | | | |
| | 0.5 Irganox ™ 1010 | | | | | | |
| 5G | 79.5 Polymer Blend A/ | 110 | 7.3 | 0/0/0 | AB/AB/ | 2-2.5 | Clear |
| | 5 Polywax ™2000/ | | | | AB | | |
| | 7.5 Regalite S5100/ | | | | | | |
| | 7.5 Regalite R1100/0.5 Irganox ™ 1010 | | | | | | |
| 6G | 79.5 Polymer Blend A/ | 105 | 9 | 42/0/0 | AB/AB/ | 1.7 | Clear |
| | 5 Polywax ™2000/3.75 H130W/ | | | | AB | | |
| | 7.5 Regalite S5100/ | | | | | | |
| | 3.75 Regalite C6100/ | | | | | | |
| | 0.5 Irganox ™ 1010 | | | | | | |
| 7G | 79.5 Polymer Blend A/ | 110 | 8 | 28/2/0 | AB/AB/ | 2 | Yellow |
| | 5 Polywax ™2000/ | | | | AB | | Clear |
| | 5.25 Regalite S5100/ | | | | | | |
| | 6 Regalite R1125/ | | | | | | |
| | 3.75 Regalite C6100/ | | | | | | |
| | 0.5 Irganox ™ 1010 | | | | | | |
| 8G | 79.5 Polymer Blend A/ | 105 | 8 | 20/10/0 | AB/AB/ | 1.5-1.7 | Clear |
| | 5 Polywax ™2000/ | | | | AB | | |
| | 1.5 Regalite S5100/ | | | | | | |
| | 3 Regalite R1125/ | | | | | | |
| | 10.5 Regalite C6100/ | | | | | | |
| | 0.5 Irganox ™ 1010 | | | | | | |
| 9G | 79.5 Polymer Blend A/ | 100 | 8 | 30/0/0 | 3AB; 3FT/ | 1.7-2 | Clear |
| | 5 Polywax ™2000/ | | | | AB/ | | |
| | 3 H100W/1.5 Regalite S5100/ | | | | AB | | |
| | 10.5 Regalite C6100/ | | | | | | |
| | 0.5 Irganox ™ 1010 | | | | | | |
| 10G | 79.5 Polymer Blend A/ | 100 | 7 | 15/0/0 | 1FT; AB/ | 2.5-2.7 | Clear |
| | 5 Polywax ™ 2000/3 H100W/ | | | | AB/ | | |
| | 1.5 Regalite S5100/ | | | | AB | | |
| | 1.5 Regalite R1100/ | | | | | | |
| | 9 Regalite C6100/0.5 Irganox ™1000 | | | | | | |
| 11G | 79.5 Polymer Blend A/ | 90 | 9 | 0/0/0 | AB/AB/ | 2-2.3 | Clear |
| | 5 Polywax ™2000/15 Picotac 7590N/ | | | | AB | | |
| | 0.5 Irganox ™ 1010 | | | | | | |
| 12G | 79.5 Polymer Blend A/ | 100 | | 7/0/0 | AB/AB/ | 1.5 | White |
| | 5 Polywax ™2000/15 Kristalex 3100/ | | | | AB | | Cloudy |
| | 0.5 Irganox ™ 1010 | | | | | | |
| 13G | 79.5 Polymer Blend A/ | 115 | 9 | 33/8/0 | AB; 3FT/ | 2.3-2.5 | Clear |
| | 5 Polywax ™2000/ | | | | AB/AB | | |
| | 1.5 Picotac 7590N/11.25 H130W/ | | | | | | |
| | 2.25 Kristalex 3085/ | | | | | | |
| | 0.5 Irganox ™ 1010 | | | | | | |
| 14G | 79.5 Polymer Blend A/ | 100 | 8 | 9/0/0 | 2FT; AB/ | 2 | Yellow |
| | 5 Polywax ™2000/ | | | | AB/AB | | Cloudy |
| | 3 Norsolene A100/12 Wingtac Extra/ | | | | | | |
| | 0.5 Irganox ™ 1010 | | | | | | |
| 15G | 79.5 Polymer Blend A/ | 100 | 6 | 0/0/0 | AB/AB/ | 2.5-2.7 | Clear |
| | 5 Polywax ™2000/ | | | | AB | | |
| | 2.25 Norsolene A110/ | | | | | | |
| | 3 Wingtac Extra/9.3 Wingtac Plus/ | | | | | | |
| | 0.5 Irganox ™ 1010 | | | | | | |
| 16G | 79.5 Polymer Blend A/ | 100 | 7 | 0/0/0 | AB/AB/ | 1.7-2 | Yellow |
| | 5 Polywax ™2000/2.7 Norsolene A110/ | | | | AB | | Cloudy |
| | 3 Wingtac Extra/9.3 Wingtac Plus/ | | | | | | |
| | 0.5 Irganox ™ 1010 | | | | | | |
| 17G | 79.5 Polymer Blend A/ | 100 | 9 | 0/0/0 | AB/AB/ | 2.3-2.5 | Yellow |
| | 5 Polywax ™2000/3.6 Norsolene A110/ | | | | AB | | Cloudy |
| | 2.4 Wingtac Extra/9 Wingtac Plus/ | | | | | | |
| | 0.5 Irganox ™ 1010 | | | | | | |
| 18G | 79.5 Polymer Blend A/ | 108 | 4.3 | 4/0/0 | AB/AB/ | 1.5-1.7 | Yellow |
| | 5 Polywax ™2000/15 Sylvalite RE110/ | | | | AB | | Cloudy |
| | 0.5 Irganox ™ 1010 | | | | | | |
| 19G | 79.5 Polymer Blend A/ | 96 | 10 | 17/0/0 | AB/AB/ | 2.5-2.7 | Yellow |
| | 5 Polywax ™2000/6 Zonatac/ | | | | AB | | Clear |
| | 9 Sylvares TP96/0.5 Irganox ™ 1010 | | | | | | |
| 20G | 79.5 Polymer Blend A/ | 96 | 9 | 18/0/0 | AB/AB/AB | | |
| | 5 Polywax ™2000/10.5 Zonatac/ | | | | | | |
| | 4.5 Sylvares TP96/0.5 Irganox ™ 1010 | | | | | | |
| 21G | 79.5 Polymer Blend A/ | 96 | 8 | 0/0/0 | AB/AB/AB | 2-2.3 | Clear- |
| | 5 Polywax ™2000/3 Zonatac/ | | | | | | Yellow |
| | 12 Sylvares TP96/0.5 Irganox ™ 1010 | | | | | | |
| 22G | 79.5 Polymer Blend A/ | 96 | 7 | 0/0/0 | AB/AB/AB | 2.3-2.5 | Clear- |
| | 5 Polywax ™2000/1.5 Zonatac/ | | | | | | Yellow |
| | 13.5 Sylvares TP96/0.5 Irganox ™ 1010 | | | | | | |
| 23G | 79.5 Polymer Blend A/ | 125 | 5 | 17/0/0 | 2FT; 4AB/ | 1.7-2 | Clear- |
| | 5 Polywax ™2000/15 FP125/ | | | | AB/AB | | Yellow |
| | 0.5 Irganox ™ 1010 | | | | | | |
| 24G | 79.5 Polymer Blend A/ | 140 | 0.8 | 0/0/0 | AB/AB/AB | 1.7-2 | Clear |
| | 5 Polywax ™2000/15 Arkon P140/ | | | | | | |
| | 0.5 Irganox ™ 1010 | | | | | | |
| 25G | 79.5 Polymer Blend A/ | 135 | 6.3 | 13/9/0 | 2FT; AB/ | 1.3-1.5 | Cloudy- |
| | 5 Polywax ™2000/15 Arkon M135/ | | | | AB/AB | | White |
| | 0.5 Irganox ™ 1010 | | | | | | |
| 26G | 79.5 Polymer Blend A/ | 125 | 0.9 | 7/0/0 | 2FT; AB/ | 1.7-2 | Clear |
| | 5 Polywax ™2000/15 I-Marv P125/ | | | | AB/AB | | |
| | 0.5 Irganox ™ 1010 | | | | | | |
| 27G | 79.5 Polymer Blend A/ | 115 | 2 | 79/14/0 | FT/AB/ | 2.3-2.5 | Clear-Haze |
| | 5 Polywax ™2000/7.5 SU230/ | | | | 1FT; AB | | |
| | 7.5 SU200/0.5 Irganox ™ 1010 | | | | | | |
| 28G | 79.5 Polymer Blend A/ | 90 | 0 | 0/0/0 | AB/AB/AB | 2.3-2.5 | Clear |
| | 5 Polywax ™2000/15 SU90/ | | | | | | |
| | 0.5 Irganox ™ 1010 | | | | | | |
| 29G | 79.5 Polymer Blend A/ | 100 | 2 | 45/0/0 | 3FT; AB/ | 2.3-2.5 | Clear |
| | 5 Polywax ™2000/15 SU200/ | | | | AB/AB | | |
| | 0.5 Irganox ™ 1010 | | | | | | |
| 30G | 79.5 Polymer Blend A/ | | | 0/0/0 | AB/AB/AB | 1.7 | Clear- |
| | 5 Polywax ™2000/15 Picotac 8095/ | | | | | | Yellow |
| | 0.5 Irganox ™ 1010 | | | | | | |
| Control | Advantra ®PHC9256 | | | 87/0/0 | FT; AB/ | 1.5 | Clear |
| | | | | | AB/AB | | |

We claim:

1. An adhesive composition comprising:
(a) a polymer blend comprising
a first propylene-based polymer, wherein the first propylene-based polymer is a homopolymer of propylene or a copolymer of propylene and ethylene or a C₄ to C₁₀ alpha-olefin; a second propylene-based polymer, wherein the second propylene-based polymer is a homopolymer of propylene or a copolymer of propylene and ethylene or a C₄ to C₁₀ alpha-olefin; wherein the second propylene-based polymer is different than the first propylene-based polymer;
wherein the polymer blend has a melt viscosity, measured at 190° C. of about 1,000 to about 30,000 cP and
wherein the polymer blend is present in the amount of about 50 wt % to about 95 wt % of the adhesive composition;
(b) a tackifier;
wherein tackifier has a softening point as determined by ASTM E-28 of about 95° C. to about 115° C., an aromaticity of about 3 mol % to about 10 mol % aromatic protons, and a Cloud Point of about 40° C. to about 65° C.; and
(c) a wax.

2. An adhesive composition comprising:
(a) a polymer blend comprising an ethylene-based polymer or a propylene-based homopolymer;
(b) a tackifier;
wherein tackifier has a softening point as determined by ASTM E-28 of about 95° C. to about 115° C., an aromaticity of about 3 to about 10 mol % aromatic protons, and a Cloud Point of 40 to about 65° C.; and
(c) a wax.

3. The adhesive composition of claim 2, where the ethylene-based polymer is selected from the group consisting of ethylene vinyl acetate and a polyethylene.

4. The adhesive composition of claim 3, wherein the ethylene vinyl acetate has about 15 wt % to about 40 wt % vinyl acetate and a melt index of about 30 g/10 min to about 1,000 g/10 min.

5. The adhesive composition of claim 3, wherein the polyethylene has a density of about 0.86 g/cm³ to about 0.9 g/cm³ and a viscosity of about 5 Pa-s to about 200 Pa-s at 177° C.

6. The adhesive composition of claim 2, where the propylene-based homopolymer has a viscosity of about 1,000 cP to about 30,000 cP at 190° C. and a softening point, as determined by ISO4625, of about 70° C. to about 130° C.

7. The adhesive composition of claim 1, wherein the polymer blend is present in the amount of about 50 wt % to about 95 wt % of the adhesive composition.

8. The adhesive composition of claim 1, wherein the wax is present in the amount of about 5 wt % to about 7.5 wt %.

9. The adhesive composition of claim 1, further comprising an antioxidant and a plasticizer.

10. The adhesive composition of claim 1, wherein the composition is substantially free of a functionalized polyolefin, selected from the group consisting of a maleic anhydride-modified polypropylene and a maleic anhydride-modified polypropylene wax.

11. The adhesive composition of claim 1, wherein the tackifier is present in the amount of about 5 wt % to about 50 wt %.

12. The adhesive composition of claim 1, wherein the tackifier may be a single tackifier or a blend of one or more tackifiers.

13. An article comprising the adhesive composition of claim 1, wherein the adhesive composition adheres one or more substrates, and wherein at least one of the one or more substrates comprises paper, cardboard, plastic, nonwoven, metal, wood, other natural fiber based material, or combinations thereof.

14. A process to prepare an adhesive composition, comprising blending
(a) a polymer blend comprising
a first propylene-based polymer, wherein the first propylene-based polymer is a homopolymer of propylene or a copolymer of propylene and ethylene or a C₄ to C₁₀ alpha-olefin; a second propylene-based polymer, wherein the second propylene-based polymer is a homopolymer of propylene or a copolymer of propylene and ethylene or a C₄ to C₁₀ alpha-olefin; wherein the second propylene-based polymer is different than the first propylene-based polymer;
wherein the polymer blend has a melt viscosity, measured at 190° C. of about 1,000 to about 30,000 cP and
wherein the polymer blend is present in the amount of about 50 wt % to about 95 wt % of the adhesive composition;
(b) a tackifier;
wherein tackifier has a softening point as determined by ASTM E-28 of about 95° C. to about 115° C., an aromaticity of about 3 mol % to about 10 mol % aromatic protons, and a Cloud Point of about 40° C. to about 65° C.; and
(c) a wax.
